(19) United States
(12) Patent Application Publication
(10) Pub. No.: US 2012/0079080 A1
(43) Pub. Date: Mar. 29, 2012

(54) Apparatuses, Methods and Systems For An Interactive Proximity Display Tether With Remote Co-Play

(76) Inventor: Shervin Pishevar, Palo Alto, CA (US)

(21) Appl. No.: 13/148,996

(22) PCT Filed: Feb. 11, 2010
(86) PCT No.: PCT/US10/23961

§ 371 Date: Dec. 8, 2011

Related U.S. Application Data
(60) Provisional application No. 61/151,832, filed on Feb. 11, 2009.

(51) Int. Cl. G06F 15/177

(52) U.S. Cl. 709/220

(57) ABSTRACT

The APPARATUSES, METHODS AND SYSTEMS FOR AN INTERACTIVE PROXIMITY DISPLAY TETHER WITH REMOTE CO-PLAY (“CO-PLAY”) teaches an interactive cooperative gameplay platform, which provides an interactive communications and display tether between a source device and a remote display device, and between a source device and a co-play client device. The CO-PLAY allows multiple users to operate an application platform, e.g., in game environments. For example, a user may employ a mobile device, such as the Apple iPhone, and launch a CO-PLAY implemented video game to query and connect to an available client device (e.g., another Apple iPhone) to co-play the video game. In one implementation, the CO-PLAY may tether the mobile device with a remote display device for visualization on a larger display.

### RELATED APPLICATIONS

Applicant hereby claims priority under 35 USC §119 for U.S. provisional patent application Ser. No. 61/151,832 filed on Feb. 11, 2009, entitled “APPARATUSES, METHODS AND SYSTEMS FOR REMOTE INTERACTIVE REALTIME CO-PLAY,” attorney docket no. 19626-004PV.

The entire contents of the aforementioned applications are herein expressly incorporated by reference.

### FIELD

The present invention is directed generally to an apparatuses, methods, and systems of interactive display, and more particularly, to APPARATUSES, METHODS AND SYSTEMS FOR AN INTERACTIVE PROXIMITY DISPLAY TETHER WITH REMOTE CO-PLAY.

### BACKGROUND

Portable game environments such as the Nintendo Gameboy, Nintendo DS, Sony PSP, and mobile communications handsets such as the iPhone, Palm, Blackberry and/or other devices allow users to engage in gaming in a mobile fashion. These devices typically have screens of portable dimension and allow users to engage in gaming on the go.

### SUMMARY

The APPARATUSES, METHODS AND SYSTEMS FOR AN INTERACTIVE PROXIMITY DISPLAY TETHER WITH REMOTE CO-PLAY (hereinafter “CO-PLAY”) provides an interactive cooperative gameplay (“co-play”) platform that allows multiple users to operate an application, e.g., in game environments. For example, a CO-PLAY facilitates a first iPhone user to participate in or “co-play” in the golf game with a second iPhone user on the same gaming platform. In another implementation, the first iPhone user may tether with a display device for larger visualization—i.e., avatars representing the first and second players may be transferred to the display device and updated based on the user manipulations of the first and second iPhones in a real-time manner, respectively.

In one implementation, the CO-PLAY enables users to view on a remote device, gameplay for gaming applications receiving input from multiple mobile device(s). The users may manipulate the mobile devices, engage and/or stimulate device sensors, and/or the like and watch the results one or more target remote display(s). The CO-PLAY thus expands the possibilities for mobile device applications, gameplay, and/or the like by allowing the user to simultaneously manipulate the mobile devices and view the results without the need to constantly check the mobile device display. In one implementation, a mobile device equipped with one or more motion-sensors may be used to play a game, such as golf or bowling, and the RCD interface may allow the user to view the gameplay on a remote display as they swing the mobile device to control the gameplay.

In some implementations, a user may use CO-PLAY to facilitate remote display between a first and a second mobile device. Furthermore, depending on the particular implementation, the Co-play IPDT may establish and maintain a persistent remote display platform across first and second mobile devices. In another example, a first mobile device initiates a tennis application with a second mobile device. The first a device establishes and maintains a communication link to facilitate generating a persistent platform as a tennis court on both mobile devices. In an implementation, the users of the first and second mobile devices, manipulate the device to control the tennis player on the commonly displayed persistent tennis court. In another implementation, the users respective devices establish and maintain the common platform, but provide a unique perspective for display on a target device that displaying the data associated with the manipulations of the respective devices.

### BRIEF DESCRIPTION OF THE DRAWINGS

The accompanying appendices and/or drawings illustrate various non-limiting, example, inventive aspects in accordance with the present disclosure:

FIG. 1 is of a block diagram illustrating an overview of an implementation of data flows between AN INTERACTIVE PROXIMITY DISPLAY TETHER WITH REMOTE CO-PLAY (hereinafter “CO-PLAY”) system and affiliated entities in one embodiment of the CO-PLAY operation;

FIG. 2 provides an implementation of IPDT system components in one embodiment of the CO-PLAY operation;

FIGS. 3A-C provides logic flow diagrams and examples of screenshots illustrating aspects of interactive proximity display tethering within embodiments of the CO-PLAY operation;

FIG. 4 provide block diagrams illustrating examples of data formats of interactive proximity display tethering within embodiments of the CO-PLAY operation;

FIG. 5A-5D illustrate example configurations of an interactive proximity display tether with co-play within one embodiment of the CO-PLAY operation;

FIG. 6A-6B provide logic flow diagrams illustrating aspects of real-m time co-play within embodiments of the CO-PLAY operation;

FIG. 7A-7B provide logic flow diagrams illustrating aspects of real-time co-play in alternative embodiments of the CO-PLAY operation;

FIG. 8A-F provide example screen shots illustrating aspects of the CO-PLAY within embodiments of the CO-PLAY operation;

FIG. 9A-C provide example diagrams and screen shots illustrating aspects of the CO-PLAY within embodiments of the CO-PLAY operation;

FIG. 10 illustrates implementations of an IPDT housing configured as a golf club in one embodiment of the CO-PLAY operation; and

FIG. 11 is of a block diagram illustrating embodiments of the CO-PLAY controller;

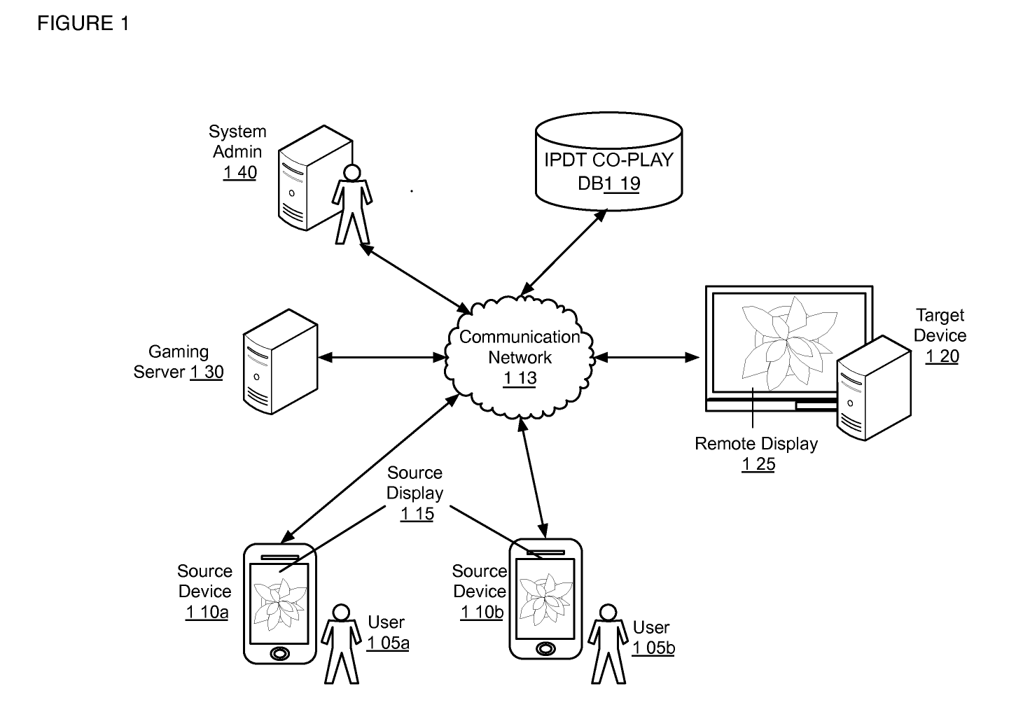

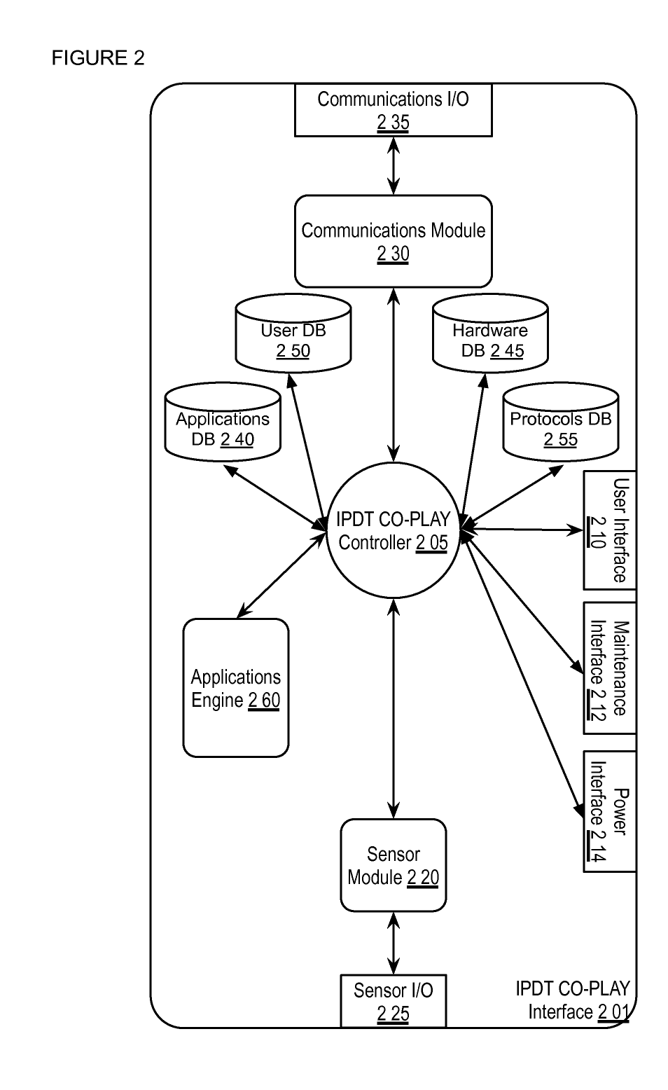

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### CO-PLAY

This disclosure details the implementation of APPARATUSES, METHODS AND SYSTEMS FOR AN INTERACTIVE PROXIMITY DISPLAY TETHER WITH REMOTE CO-PLAY (hereinafter “CO-PLAY”). CO-PLAY implements an interactive application at a user handset to tether with a target device and/or another user handset whereby users may project a local screen running a gaming application on the handsets a to a larger display device.

For example, in one embodiment, CO-PLAY may be implemented on various mobile devices, such as on a smart phone platform, e.g. Apple's iPhone OS, Google's Android OS, Microsoft's Windows Mobile, Blackberry's OS, and/or the like. In one embodiment, a user operating such a mobile device may select to play with a CO-PLAY gaming application from his/her mobile device, e.g. an iGolf game, etc. If the user launch the CO-PLAY application, for example, by clicking a CO-PLAY enabled application and/or component icon from the mobile device screen menu, the mobile device may query for available target devices within a local area network. For instance, in one implementation, the mobile device may search for a laptop, a desktop, a projector, a television, and/or the like that are registered within a Wi-Fi, Bluetooth, etc. range. The user may then be provided a list of search results of available target device and may enter a selection. In one implementation, the user may choose a television, and the mobile device may establish a communication channel and tether with the television. In one implementation, the gaming screen on the mobile device may be projected to a larger display of the television, which allows the user to operate the mobile device as a remote game controller while the video gaming screen is displayed in a real-time and interactive manner on the television.

For another example, in one implementation, a user operating a first mobile device may select to co-play a game with a second user operating a second mobile device, e.g., an iTennis application. In that case, the first device may establish and maintain a communication link to facilitate generating a persistent platform connection as a tennis court on both mobile devices. In one implementation, the users of the first and second mobile devices, manipulate the device to control the tennis player on the commonly displayed persistent tennis court. In another implementation, the users respective devices establish and maintain the common platform, but provide a unique perspective for display on a target device that displaying the data associated with the manipulations of the respective devices.

In one embodiment, a method is disclosed, comprising: receiving a request to initialize an interactive co-play component; querying for co-play client devices; providing a list of available co-play client devices based on the query; obtaining a selection of a co-play client device; configuring a communications channel for the selected co-play client device; and instantiating the interactive co-play component through the communications channel.

FIG. 1 is of a block diagram illustrating an overview of an implementation of data flows between a CO-PLAY system and affiliated entities in one embodiment of the CO-PLAY operation. In FIG. 1, a user (or users) 105a/b operating a source device 110a/b, a target device 120 with a remote display 125, a CO-PLAY database 119, a gaming server 130, and a system administrator 140 are shown to interact via a communication network 113.

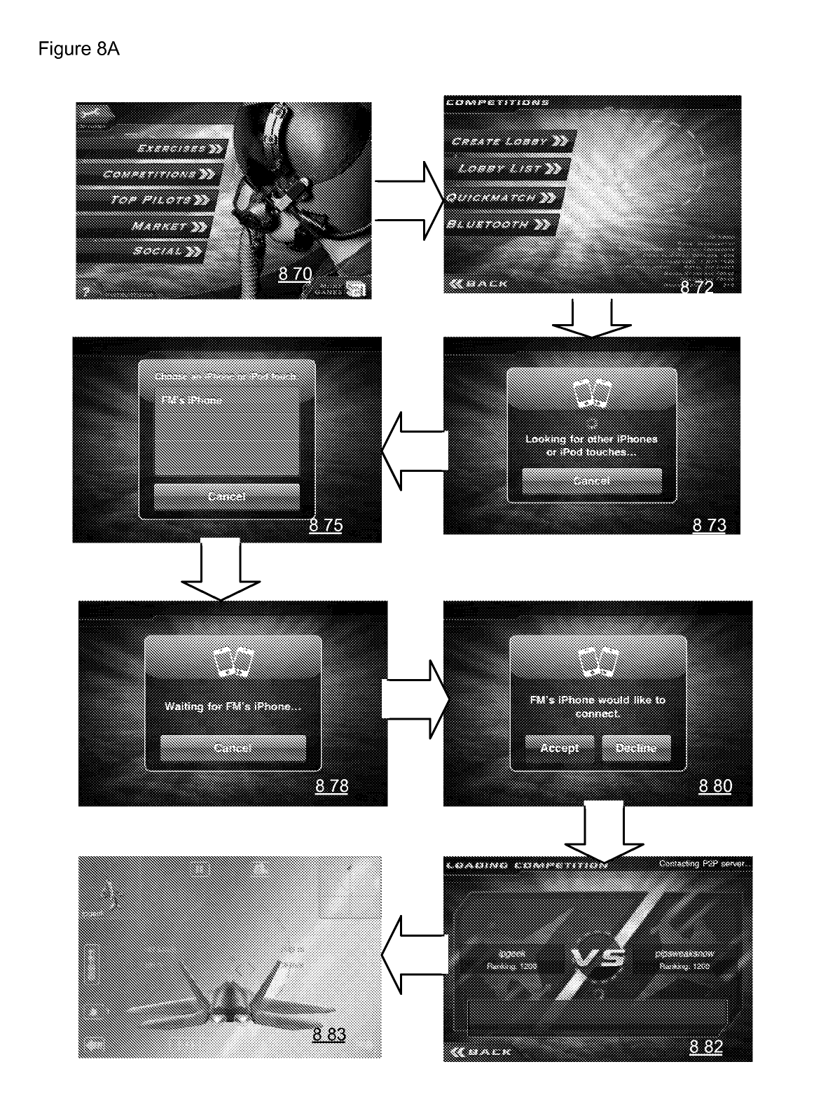

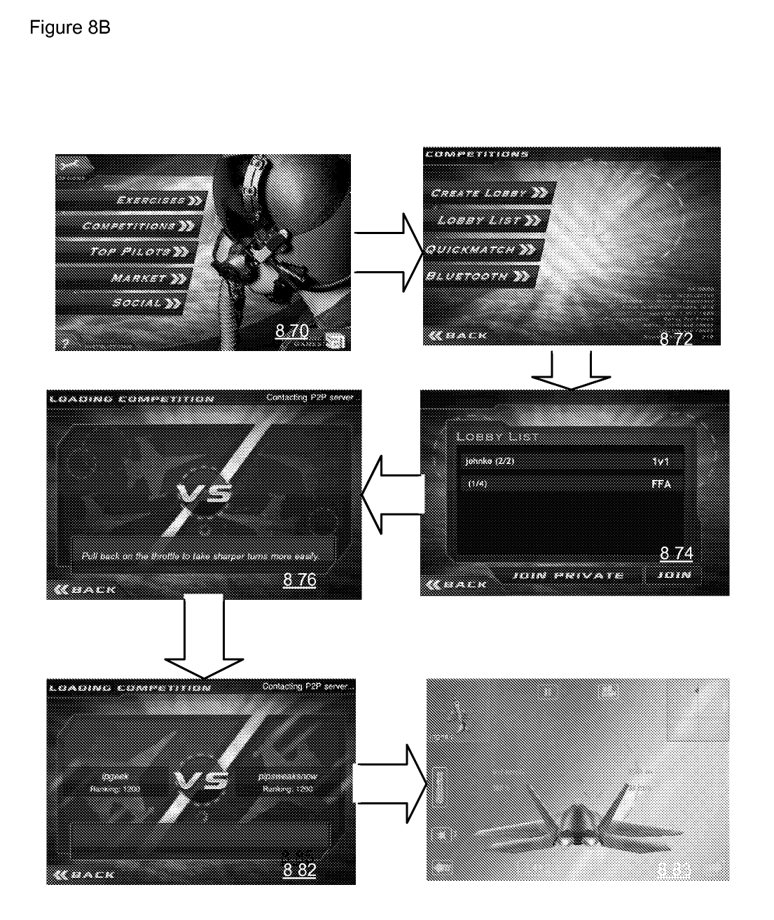

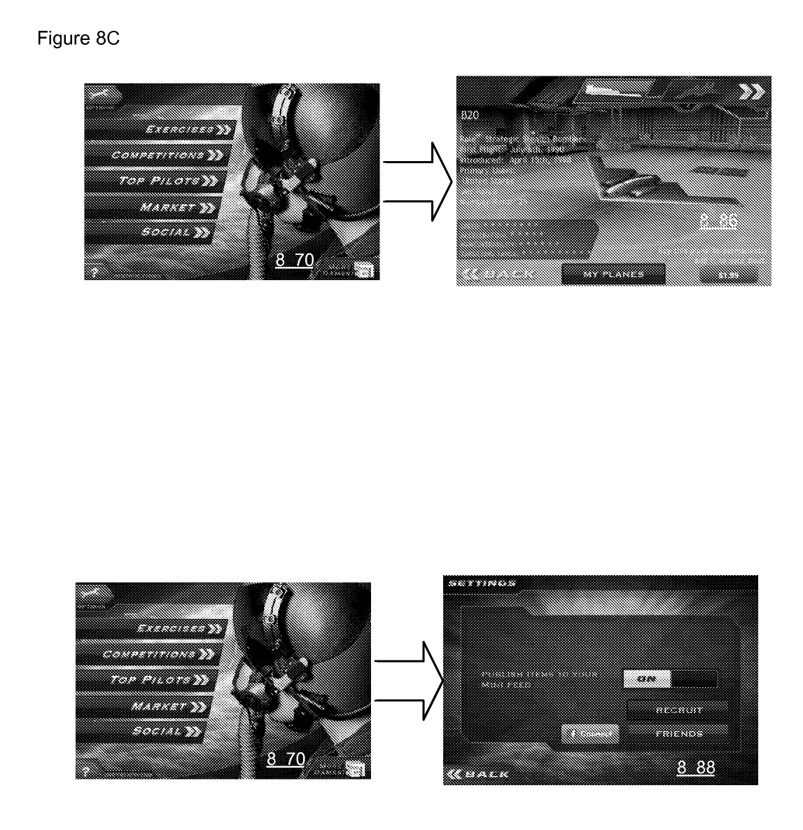

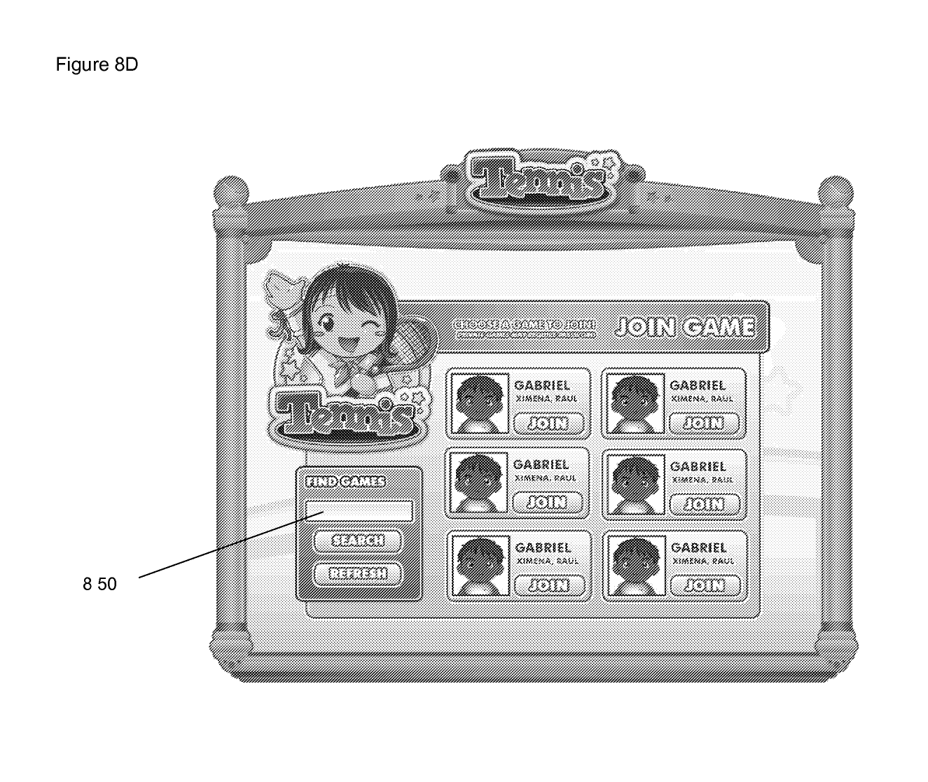

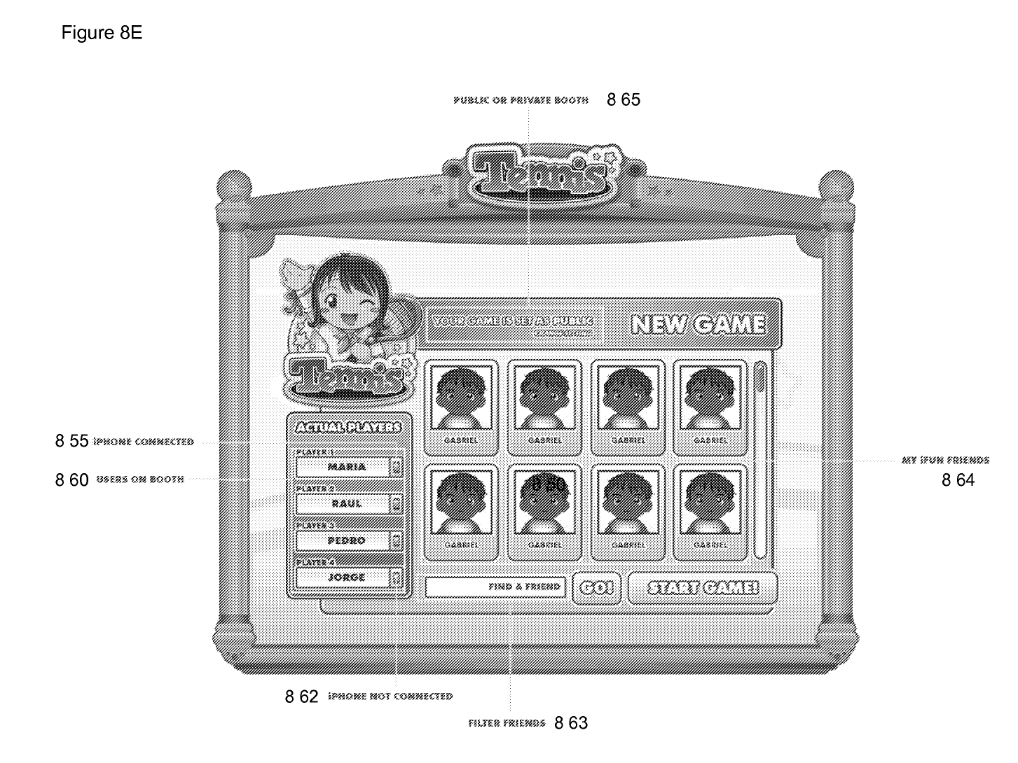

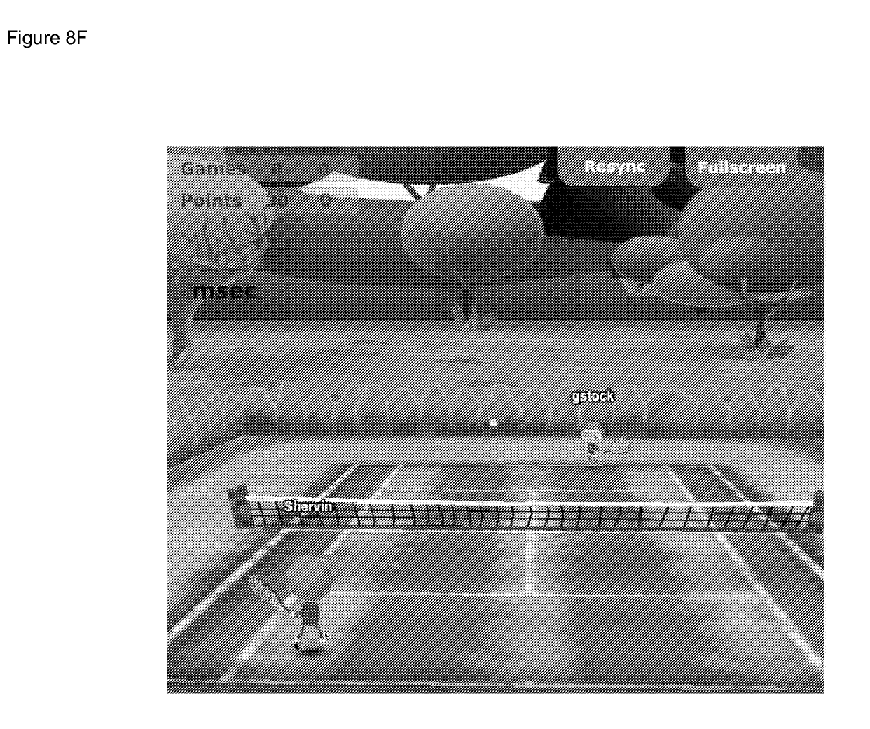

In one embodiment, a user 105a may operate with a source device 110a to connect to and share a screen of the source display 115 of the source device with a remote display 125 of a target device 120. The source device 110a may include a wide variety of different devices and technologies such as, but not limited to mobile devices, dedicated game handsets, general computing devices, and/or the like. The target devices 120 may include devices and technologies such as mobile handsets, dedicated game handsets, general computing devices, game consoles, set top boxes, cable boxes, video displays, and/or the like. For example, as illustrated in FIG. 1, in one implementation, the source device noa may be a portable handset, such an Apple Inc. iPhone, while the target device 120 may be a computer with a display screen 125. For another example, the source device 110a may be a mobile device such as an Apple iPhone secured in a housing shaped as a gaming implement, such as a golf club for a golf game (as will be further illustrated in one implementation in FIG. 8), tennis racket for tennis game, fishing pole for a fishing game, baseball bat for a baseball game, and/or the like.

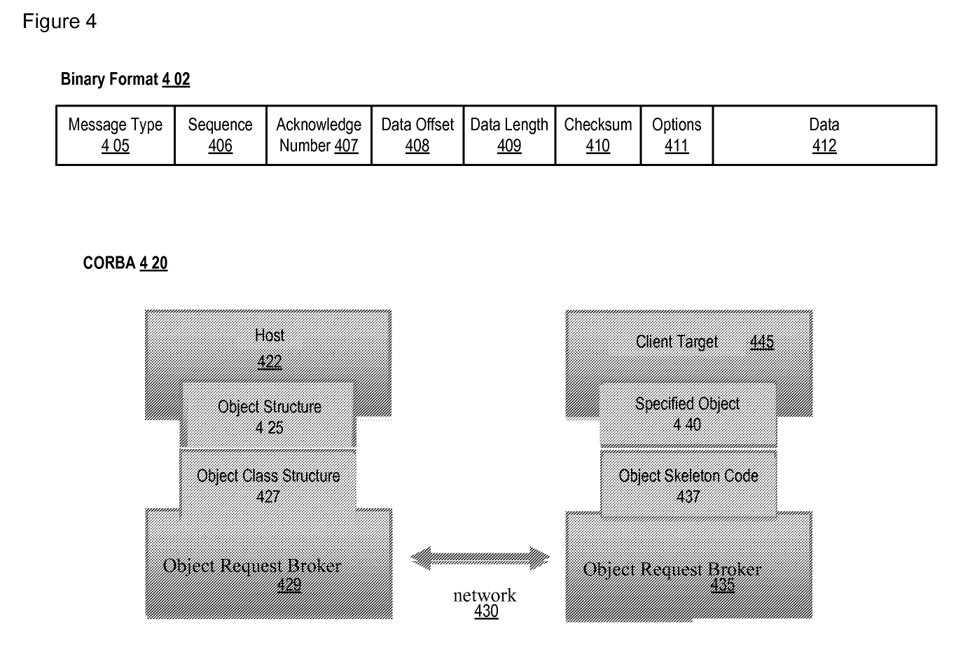

The CO-PLAY facilitates connections through the communication network 113 based on a broad range of protocols that include WiFi, Bluetooth, 3G cellular, Ethernet, physical tethers (e.g., iPhone Video AV to Dock Connector Cable, which allows for connection to a monitor or TV), and/or the like. In one embodiment, the communication network 113 may be the Internet, a Wide Area Network (WAN), a telephony network, a Local Area Network (LAN), a Peer-to-Peer (P2P) connection, and/or the like. In one embodiment, the source device 110 may detect, handshake and interact with the target device 120 to exchange control information and data payloads via the communication network 113, as will be further illustrate in one implementation in FIG. 4. For example, in one implementation, the communication network 113 provides a communications path such that the source device 110 may project its source display 115 onto the target device remote display 125 one of which may also open the communication path to another source device 110b. In this manner, a relatively small source device may drive a larger display on a target display, as well as communication with one or more client devices, allowing for tethered and interactive control by the source device using the remote display 125.

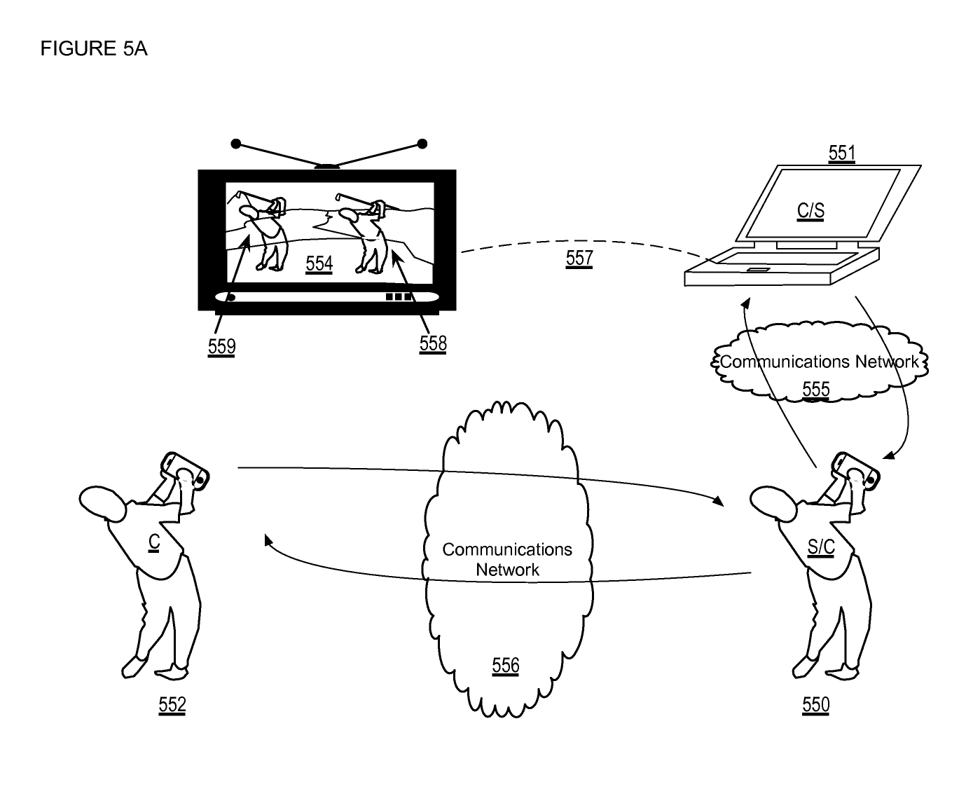

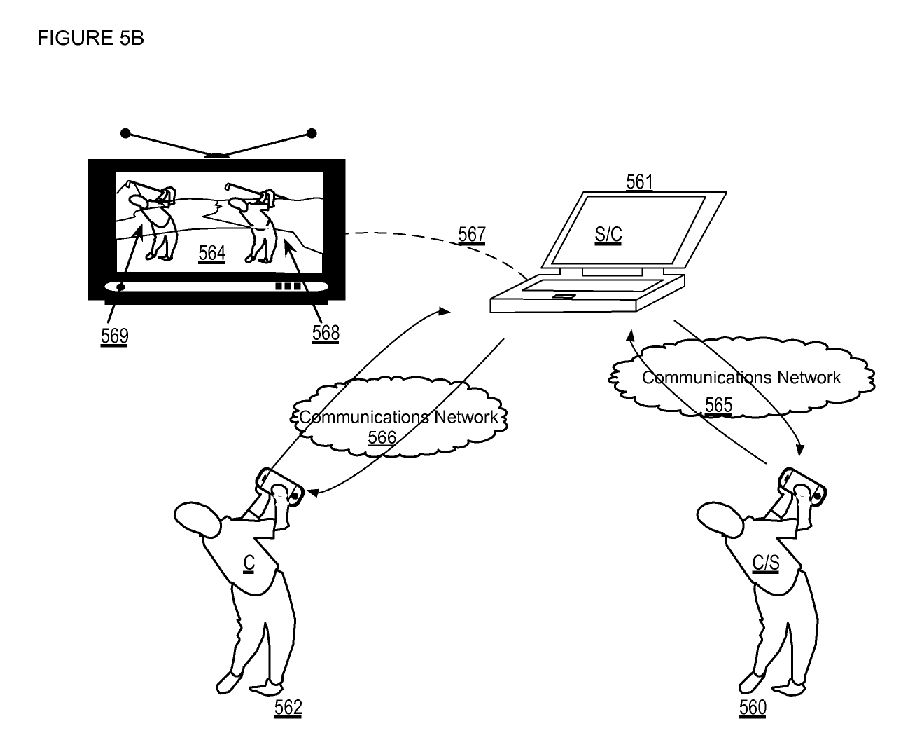

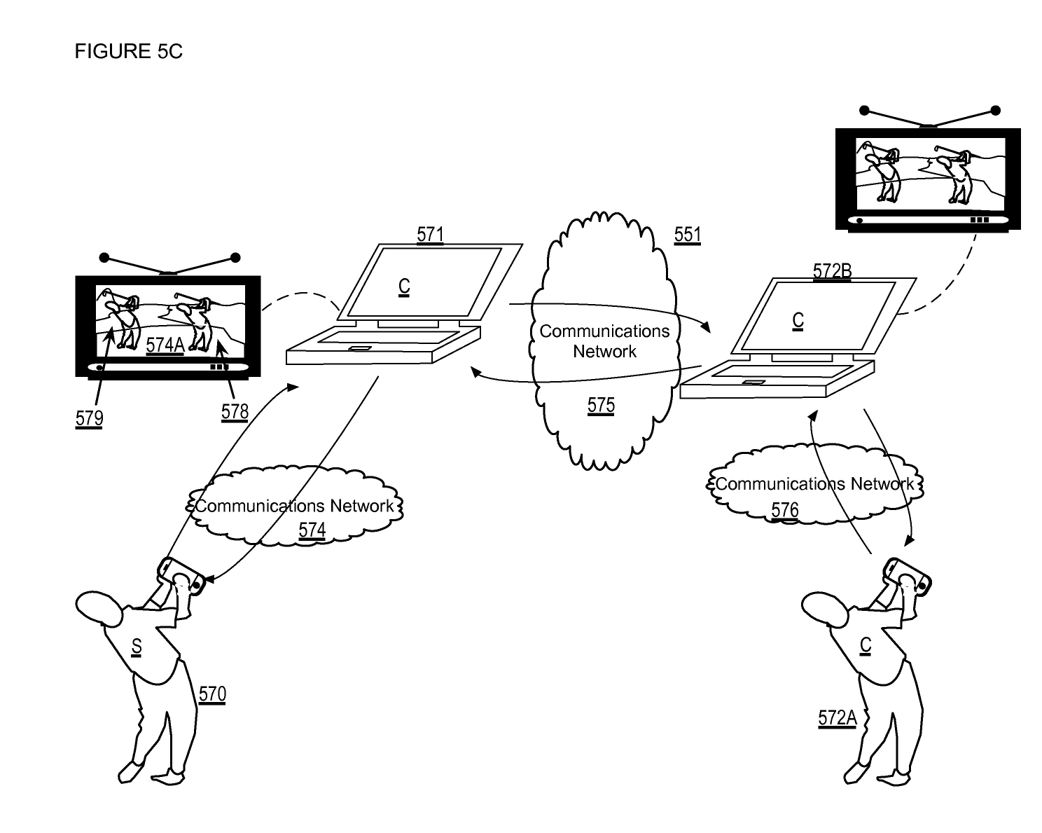

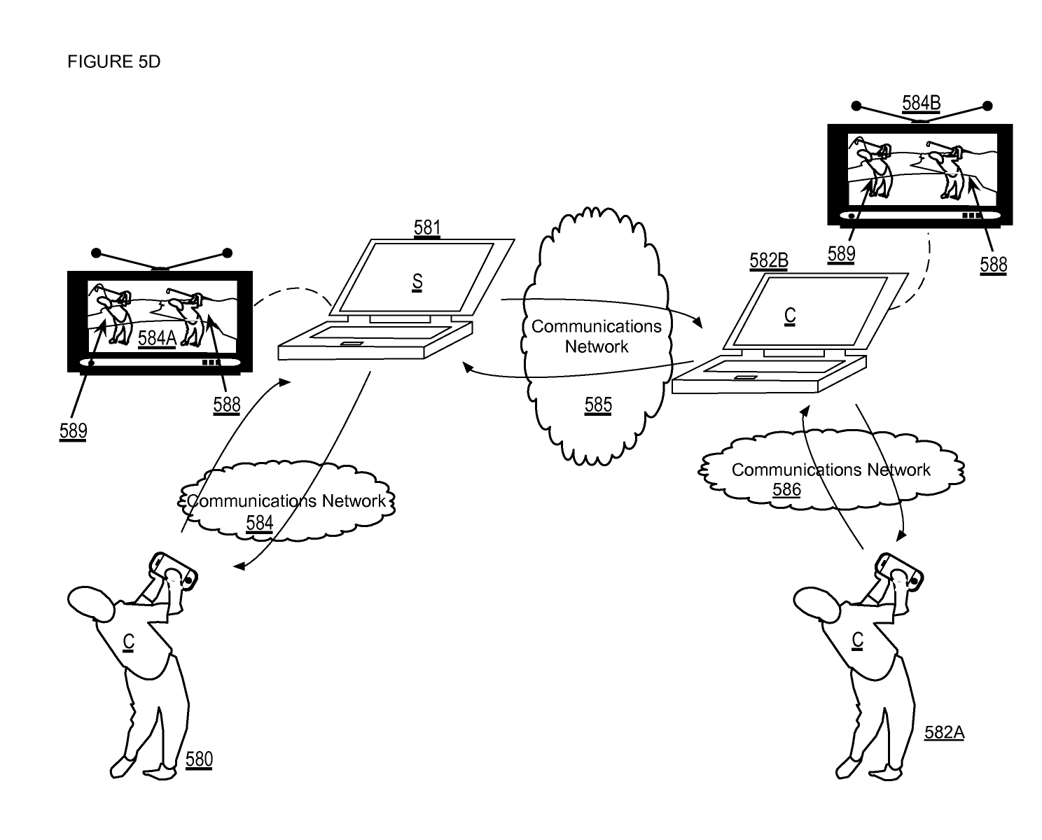

In another embodiment, the CO-PLAY may implement an interactive control scheme that allows for the interactive control of games by one or more source devices 110a/b via the larger remote display 125 of the target device 120. For example, in one implementation, a user 105a may co-play a gaming application displayed at the target device with another user 105b. In this manner, the source device ma may be configured to query and communicate with another source device 110b as a client device, as will be further illustrated in one implementation in FIGS. 5A-5D.

In one embodiment, the CO-PLAY entities such as the source device 110, the target device 120 and/or the like, may also communicate with a CO-PLAY database 119. In some embodiments, distributed CO-PLAY databases may be integrated in-house with the target device 120, and/or the source devices 110a/b. In other embodiments, the CO-PLAY entities may access a remote CO-PLAY database 119 via the communication network 113. In one embodiment, the CO-PLAY entities may send data to the database 119 for storage, such as, but not limited to user account information, application data, protocol data, application history, and/or the like.

In one embodiment, the CO-PLAY database 119 may be one or more online database connected to a variety of vendors, such as hardware vendors (e.g. Apple Inc., Intel, Sony, etc.), gaming application vendors (e.g. Nintendo, Game Cube, Game Boy, etc.), service vendors (e.g. PlayStation Network, WiiConnect24, etc.) and/or the like, and obtain updated hardware driver information, new gaming application packages and services from such vendors. In one embodiment, the source device 110 and/or the target device 120 may constantly, intermittently, and/or periodically download updates, such as updated user profile, updated software programs, updated command instructions, and/or the like, from the CO-PLAY database 119 via a variety of connection protocols, such as Telnet FTP, HTTP transfer, P2P transmission and/or the like.

In a further embodiment, the target device 120 and the source device 110 may connect to an online gaming server 130 via the communication network 113. For example, in one implementation, users 105a/b may employ source devices 110a/b to join an Internet game community (e.g. F.A.S.T., etc.) at an online gaming server 130, which is locally displayed at the target device 120.

In one embodiment, a system administrator 140 may communicate with the CO-PLAY entities for regular maintenance, service failure, system updates, database renewal, security surveillance and/or the like via the communication network 113. For example, in one implementation, the system administrator may be a user, who may directly operate with the target device 120 to configure system settings, parental control, and/or the like. In another implementation, the system administrator may be a service vendor for Internet gaming.

FIG. 2 illustrates an implementation of CO-PLAY system components in one embodiment of CO-PLAY operation. A CO-PLAY device 201 may contain a number of functional modules and/or data stores. A CO-PLAY controller 205 may serve a central role in some embodiments of CO-PLAY operation, serving to orchestrate the reception, generation, and distribution of data and/or instructions to, from and between target device(s) and/or client device(s) via CO-PLAY modules and in some instances mediating communications with external entities and systems.

In one embodiment, the CO-PLAY controller 205 may be housed separately from other modules and/or databases within the CO-PLAY system, while in another embodiment, some or all of the other modules and/or databases may be housed within and/or configured as part of the CO-PLAY controller. Further detail regarding implementations of CO-PLAY controller operations, modules, and databases is provided below.

In one embodiment, the CO-PLAY Controller 205 may be coupled to one or more interface components and/or modules. In one embodiment, the CO-PLAY Controller may be coupled to a user interface (UI) 210, a maintenance interface 212, and a power interface 214. The user interface 210 may be configured to receive user inputs and display application states and/or other outputs. The UI may, for example, allow a user to adjust CO-PLAY system settings, select communication methods and/or protocols, initiate a remote display mode, engage mobile device application features, identify possible target/client device(s) and/or the like. In one implementation, the user interface 210 may include, but not limited to devices such as, keyboard(s), mouse, stylus(es), touch screen(s), digital display(s), and/or the like. In one embodiment, the maintenance interface 212 may, for example, configure regular inspection and repairs, receive system upgrade data, report system behaviors, and/or the like. In one embodiment, the power interface 214 may, for example, connect the CO-PLAY controlled 205 to an embedded battery and/or an external power source.

In one embodiment, the CO-PLAY Controller may further be coupled to an applications engine 260, configured to run device application software. In one implementation, the applications engine 260 may receive sensory input information originating from one or more integrated sensors and interpret the information to update the configuration of an application state. In an implementation the updated application state data may be transferred to a target, client and/or source device depending on the implementation for display. For example, an application run by the applications engine may comprise a video game, such as may be controlled via a motion-sensitive mobile device, which uses CO-PLAY to establish a communications channel with a laptop, configured in turn, to display transferred video game data.

In one implementation, the CO-PLAY Controller 205 may further be coupled to a sensor module 220, configured to interface with and/or process signals from sensor input/output (I/O) components 225. The sensor I/O components 225 may be stimulated by user manipulation, environmental conditions, and/or the like to generate electrical signals that may be received and/or processed by the sensor module 220 and/or other CO-PLAY components, which in turn act to generate input controls which can be used by the application. A wide variety of different sensors may be compatible with CO-PLAY operation and may be integrated with sensor I/O components 225, such as but not limited to transducers, accelerometers, thermometers, anemometers, barometers, microphones, and/or the like, configured to measure states of motion, sound level, volume, pitch, pressure, wind speed, temperature, data transfer rate, light intensity level, position, elevation, weather, moisture level, humidity, and/or a the like. In one implementation, the sensor module 220 may configure signals received from the sensor I/O components 225 in a form suitable for an application being run by a the applications engine 260. In another implementation, the applications engine 260 may receive signals directly from sensor I/O components 225 for processing to update an application state for one or more running applications. For example, in one implementation, a user may engage a CO-PLAY remote control device housing in a golf club (as will be further illustrated in one implementation in FIG. 8). The user may swing the remote control device as if swinging a real golf club in field, and the sensor I/O 225 may detect signals of the motion of the club and transfer the signals (e.g. electrical pulses from accelerometers indicating a velocity and a direction of a swing, etc.) is suitable to the sensor module 220. The sensor module 220 may process and analyze the received signals and generate data describing characteristics of the movement, e.g. direction of the movement, speed of the movement, motion level, etc., and transmit the data to the CO-PLAY controller 205. For example, in one embodiment, the iPhone SDK toolkit and/or runtime libraries may be installed and/or used to access and interpret such actions.

In one embodiment, the CO-PLAY Controller 205 may further be coupled to a communications module 230, configured to interface with and/or process signals from communications I/O components 235. The communications I/O components 235 may comprise components facilitating transmission of electronic communications via a variety of different communication protocols and/or formats as coordinated with and/or by the communications module 230. Communication I/O components 240 may, for example, contain ports, slots, antennas, amplifiers, and/or the like to facilitate transmission of display instructions, such as may instruct a remote display what and/or how to display aspects of a mobile device application state, via any of the aforementioned methods. Communication protocols and/or formats for which the communications module 230 and/or communications JO components 235 may be compatible may include, but are not limited to, GSM, GPRS, W-CDMA, CDMA, CDMA2000, FISDPA, Ethernet, WiFi, Bluetooth, USB, and/or the like. In various implementations, the communication I/O 235 may, for example, serve to configure data into application, transport, network, media access control, and/or physical layer formats in accordance with a network transmission protocol, such as, but not limited to FTP, TCP/IP, SMTP, Short Message Peer-to-Peer (SMPP) and/or the like. The communications module 230 and communications I/O 235 may further be configurable to implement and/or translate Wireless Application Protocol (WAP), VoIP and/or the like data formats and/or protocols. The communications I/O 235 may further house one or more ports, jacks, antennas, and/or the like to facilitate wired and/or wireless communications with and/or within the CO-PLAY system. For instance, in the above example, the CO-PLAY controller 205 may transmit the received sensor data characteristics of the movement of the controller device to the communication module 230, and the data may then be transmitted to external entities (e.g. the target device, etc.) through the communications I/O 235.

Numerous data transfer protocols may also be employed as CO-PLAY connections, for example, TCP/IP and/or higher protocols such as IITTP post, FTP put commands, and/or the like. In one implementation, the communications module 230 may comprise web server software equipped to configure application state data for publication on the World Wide Web. Published application state data may, in one implementation, be represented as an integrated video, animation, rich internet application, and/or the like configured in accordance with a multimedia plug-in such as Adobe Flash. In another implementation, the communications module 230 may comprise remote access software, such as Citrix, Virtual Network Computing (VNC), and/or the like equipped to configure application state data for viewing on a remote client (e.g., a remote display device).

In one implementation, the CO-PLAY controller 205 may further be coupled to a plurality of databases configured to store and maintain CO-PLAY data. An applications database 240 may contain application data, user IDs, settings, configurations, saved games, game states, application interface elements, and/or the like. A protocols database 245 may include data pertaining to communication protocols and/or data configurations suitable for publication on the World Wide Web, sharing between client and server devices in a remote-access software setup, and/or the like. A user database 250 may contain information pertaining to account information, contact information, profile information, identities of hardware devices, Customer Premise Equipments (CPEs), and/or the like associated with users, application history, system configurations, and/or the like. A hardware database 245 may contain information pertaining to hardware devices with which the CO-PLAY system may communicate, such as but not limited to user devices, display devices, target devices, Email servers, user telephony devices, CPEs, gateways, routers, user terminals, and/or the like. The hardware database 228 may specify transmission protocols, data formats, and/or the like suitable for communicating with hardware devices employed by any of a variety of CO-PLAY affiliated entities.

In one embodiment, the CO-PLAY databases may be implemented using various standard data-structures, such as an array, hash, (linked) list, struct, structured text file (e.g., XML), table, and/or the like. For example, in one implementation, the XML for the User Profile in the user database 250 may take a form similar to the following example:

<User>

<Quasi-static info>

<User_ID>123-45-6789</User_ID>
<Hardware ID> SDASFK45632_iPhone 3.0 </Hardware ID>
<Census info> John Smith; 123 Maple Dr., Smalltown, CA

92676; (123)456-7890; jsmith@email.com; 55 years; male; white;
married; 2 children; etc.

</Census info>

...
</Quasi-static info>
<Dynamic info>
<Application history>
<Last login>

<Server ID> US-CA-ADD00089 </Server ID>
<Time> 19:33:25 08-30-2009 </Time>
...

</Last login>

...
</Application history>

</ Dynamic info>

</User>

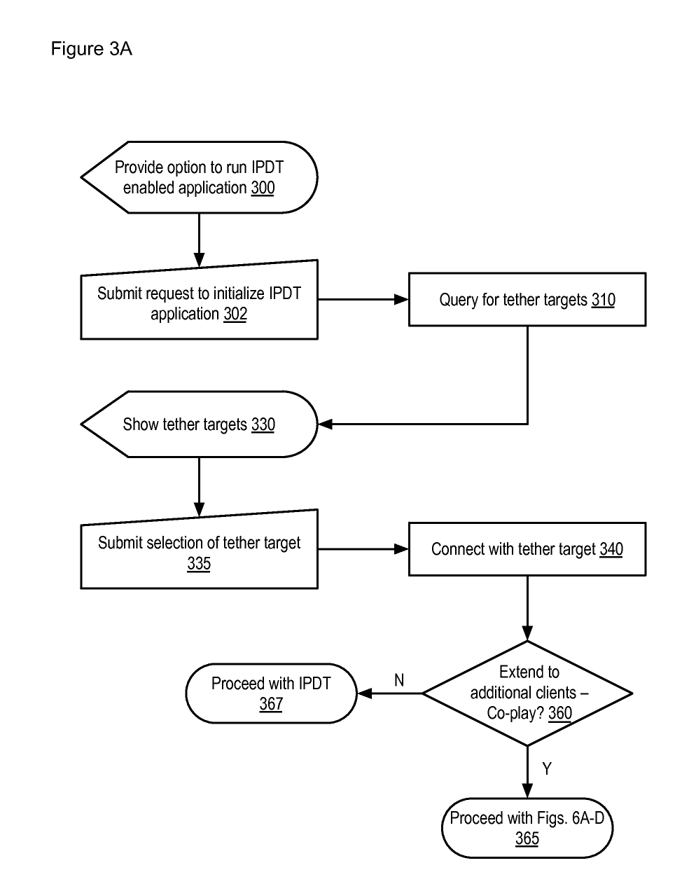

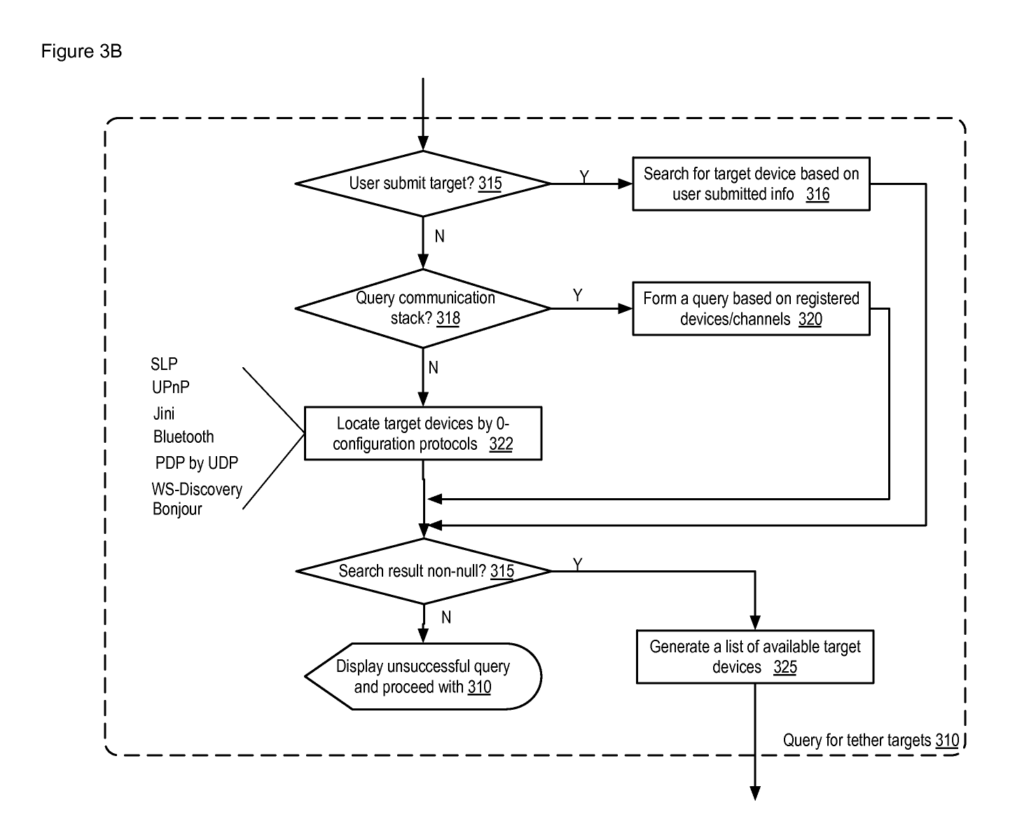

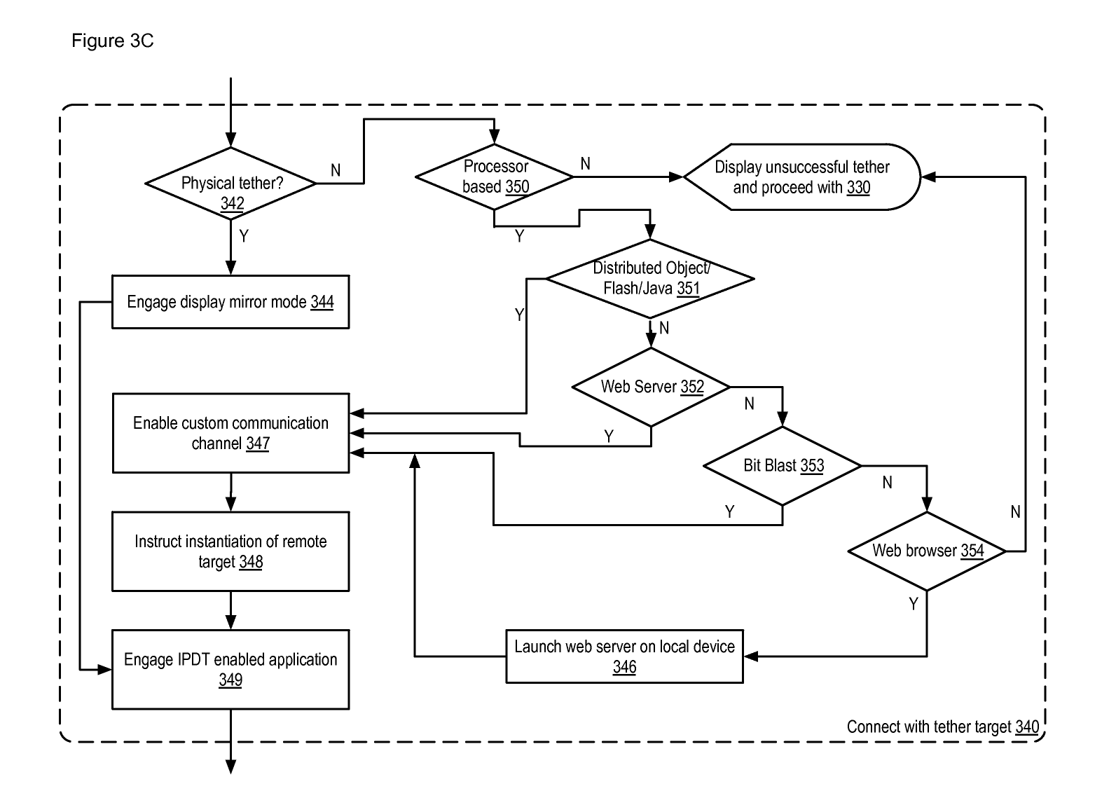

FIG. 3A is of a logic flow diagram illustrating aspects of interactive proximity display tethering within embodiments of the CO-PLAY operation. In one embodiment, a user wishing to tether a remote display may engage an application that is implemented with a CO-PLAY component. In an implementation, the CO-PLAY component may be implemented as a software development kit (SDK) and/or as an object library that may be included in any application where a CO-PLAY may be useful. In one embodiment, any program that incorporates the CO-PLAY component may become available and/or downloaded and installed on a source device, where a user will have the option to run the CO-PLAY application 300, and a user may submit request to initialize the CO-PLAY application 302. For example, in one implementation, a user may initialize a “remote game control” application from a CO-PLAY mobile device by selecting a CO-PLAY icon from the iPhone menu, and enter a CO-PLAY gaming application, as illustrated in one implementation in screen 870 of FIG. 3D. Once the application is selected and begins its instantiation, the CO-PLAY component may query for tether targets where the source device may search for appropriate tether devices via all of its communication channels 310, as illustrated in one implementation in screen 372 of FIG. 3D. In one embodiment, the CO-PLAY component may search for available target devices within a local area network based on the registered devices and/or communications channels in the source devices communication stack in the hardware database, and/or based on zero configuration protocols, and/or based on user submitted target information, as will be further illustrated in FIG. 3B.

In one embodiment, the source device may then provide the user with a list of potential tether targets 330 from which the user may make a selection 335, as illustrated in one implementation in screen 373 of FIG. 3D. Upon selecting a target device, the source device may then connect with the selected tether target 340 based on the type of the tether target 340, as illustrated in one implementation in screens 375 and 378 of FIG. 3D and will be further illustrated in FIG. 3C. Once the CO-PLAY is established, the CO-PLAY may attempt to incorporate additional clients to facilitate CO-PLAY 365, otherwise the source and target devices may proceed with the CO-PLAY 367 (as illustrated in one implementation in screen 380 of FIG. 3D). This type of CO-PLAY may be extended to facilitate Co-play CO-PLAY as described below in the example implementations of FIGS. 5A-5D wherein target devices assume Server responsibilities for the illustrated Co-play CO-PLAY implementations.

FIG. 3B illustrates aspects of querying for tether targets within embodiments of the CO-PLAY operation. In one embodiment, if a user submit an indication of target device 315, the CO-PLAY may search for target device based on the user submitted information 316. For example, in one implementation, a user may enter the known IP address, MAC address, acronym, hardware label, digital signature, driver certificate, zero-configuration information, and/or the like of a target device via a mobile device, and the mobile device may search within an available range of a local area network for the corresponding indications. Otherwise, if there is no user submitted indications, the CO-PLAY may determine whether to query the communication stack in the hardware database 318. For example, in one implementation, the CO-PLAY may display a message to a user and receive an indication from the user to determine whether to query the database. If yes, the CO-PLAY may form a query on the communication stack for registered devices/communication channels that are compatible with the source device 320. Otherwise, if not, the CO-PLAY may start a search to locate suitable target devices within a range of local area network by zero configuration protocols 322, such as, but not limited to Service Location Protocol (SLP), Universal Plug and Play (UPnP), Jini, Bluetooth Service Discovery Protocol, WS-Discovery, Proprietary Discovery Protocol, Bonjour and/or the like.

In one embodiment, the tether target device may broadcast its availability and publish a server via a zero-configuration network, e.g. an Apple SDK may create Bonjour service. For example, in one implementation, the C++ implementation based on Bonjour for creating a service and publishing the tether target may take a form similar to:

//Creating the Bonjour Service
CFNetService netService = CFNetServiceCreate(NULL, CFSTR(“”),
type, name, port);

...

```
// Publishing the Server
void init (CFNetServiceRef netService)
{
  CFStreamError error;
  CFNetServiceClientContext context = { 0, NULL, NULL, NULL,
  NULL };
  CFNetServiceSetClient(netService, registerCallback, &context);
  CFNetServiceScheduleWithRunLoop(netService,
CFRunLoopGetCurrent( ), kCFRunLoopCommonModes);
  CFNetServiceRegister(netService, NULL);
  if (CFNetServiceRegister(netService, &error) == false) {
```

CFNetServiceUnscheduleFromRunLoop(netService,

CFRunLoopGetCurrent( ),kCFRunLoopCommonModes);

CFNetServiceSetClient(netService, NULL, NULL);
CFRelease(netService);

}

}

...

For another example, the C/C++ implementation based on Proprietary Discovery Protocol for creating a service and broadcasting service information as a tether target, may take a form similar to:

//Broadcast Service Information
...
SOCKET sock;
sock = socket(AF_INET,SOCK_DGRAM,0);
char broadcast = ‘1’;
int sres = setsockopt(sock,SOL_SOCKET,SO_BROADCAST,&broadcast,sizeof(broadcast))
if (sres < 0)
{

closesocket(sock);
return 0;

}
struct sockaddr_in recv;
int len = sizeof(struct sockaddr_in);
char msg[ ] =“CO-PLAY PC V1.01”;
recv.sin_family = AF_INET;
recv.sin_port = htons(MYPORT);
recv.sin_addr.s_addr = INADDR_BROADCAST;
sendto(sock,sendMSG,strlen(msg)+1,0,(sockaddr *)&recv,sizeof(recv));
...

In one embodiment, if such query returns a null result 315, the CO-PLAY may display a message to the user indicating the search is unsuccessful, and may proceed with 310 upon user request. If the query returns at least one result 315, the CO-PLAY may generate a list of available target devices 325, and proceed with 330.

FIG. 3C illustrates aspects of connecting with tether target within embodiments of the CO-PLAY operation. The CO-PLAY may determine whether the target is a physical tether 342. If the target device is connected via a physical tether 342, for example, a direct audio/video connection such as an iPhone Video AV to Dock Connector Cable that is plugged directly into a large television, then the CO-PLAY application may begin communicating data associated with the display of the source device 344 to the larger remote display device via the physical tether, and the application may continue to execute taking advantage of a larger display 349. In an alternative embodiment, the physical tether may be a Casio XJ-S57 with a WiFi YW-2 adapter connected via WiFi. In one embodiment, the source device may transmit data to the target device through the physical tether in a variety of formats, such as, but not limited to Component VideoS-Video, HDMI, VGA, DVI, DisplayPort and/or the like.

In one embodiment, if the target is not a physical tether 342, the CO-PLAY may determine whether the target is a processor-based device/entity 350. IF not, the CO-PLAY may display a message to the user indicating the tether is unsuccessful and proceed with 330 upon user request. In one implementation, If the remote device is a processor based device 350, the source device may discern if the target device is capable of executing complementary application code as the remote device—for example: if the remote device is running a distributed object oriented application 351, if the remote device is running a web server 352, if the remote device is running a remote display client (e.g., citrix, VNC, etc.) 353, or a web browser 354. As already discussed, if the device is broadcasting based on a zero-configuration protocol (e.g. Bonjour, SLP, UPnP, Jini, Bluetooth Service Discovery Protocol, WS-Discovery, Proprietary Discovery Protocol, and/or the like) or responding to a proprietary communication request, then the tether target is processor-based,

In one embodiment, if the target computer is running a web browser 354, the source device may run a web server. For example, if the source device is an iPhone running UNIX, an Apache information server may be made part of the CO-PLAY component, and that information server may be instantiated. At that point, the source device can provide an IP address and/or register itself via zero configure network protocols like Bonjour, and a user may use the web browser on the target machine to navigate to the web server on the source device. In one embodiment, an iPhone would be the source device and run an Apache web server, and a user at a target device, e.g., an laptop, would navigate to the IP address of the web server on the iPhone over a WiFi connection. At this point a custom communication channel has been established between the source and target devices 347, and the source device may provide instructions via its web server to instantiate the remote target, e.g., provide applications executable by the target web browser 348. At this point, the source application may engage the CO-PLAY application 349 and use the custom application channel as a conduit to render its source display onto the remote display. For example, the source device web server may have a Java and or Flash applet that it will provide to the target device which provides the target device with the capability of remote display viewing. As another example, a TightVNC Java Viewer applet may be downloaded by the target web browser from the remote iPhone Apache web server and instantiated with configuration (e.g., with the IP address, set user/password keys, etc.) to connect to a VNC server that has been launched on the source device. In this manner, the target devices web browser becomes the remote display for the source device. In one embodiment, the source devices web server may instruct the target devices web browser to expand its window to the full size of the screen, thus providing an enlarged viewing area effectively mirroring the display on the source device.

In one embodiment, if the target device already has a remote desktop sharing component 353 such as Visual Network Computing (VNC), Apple's remote display technology reachable via Bonjour, and/or the like, the user may be prompted with a screen instructing them on what to enter on the target device to complete the connection (e.g., IP address, user/password, help to access proper areas of the operating system, etc.) and configure a custom communications channel 347. In one embodiment, the source device will launch a VNC server as part of the CO-PLAY component which will be viewable in the shared area of the Apple OS X Finder application, and may be selected for screen sharing, thereby instantiating the remote target 348 to project the source device's display to the target. At this point, the CO-PLAY application may continue to execute 349. For example, in one implementation, a C++ implementation for an iPhone to connect to a service based on Bonjour may take a form similar to:

// Connecting to a Service
NSNetService *service;
NSInputStream *istream = nil;
NSOutputStream *ostream = nil;
[service getInputStream:&istream outputStream:&ostream];
if (istream && ostream)
{

// ...

}

In one embodiment, if the target device is running either a custom application 351 and/or web server configured to communicate with source devices 352, the source device has a number of channels over which it may communicate. In the case of distributed object oriented application, object oriented method calls may be sent to the target application to establish a connection. These custom applications may employ similar remote display technologies as already discussed. In another embodiment, where a source application uses a graphics rendering engine such as Open GL, Flash, and/or Apple's OS X development SDK, where such graphics libraries scale depending on a devices display abilities, the source device may be used as an input device, and the target device may run a more robust version of CO-PLAY application stored on the source device.

The more robust version of the CO-PLAY application may be provided to the target device in a number of ways. In one embodiment, the CO-PLAY source application has a directory having multiple versions of the application, and may transfer more elaborate versions to the target device. In another embodiment, the CO-PLAY source application will have a web link and have the target device automatically download the more elaborate applet and/or application and have that installed and instantiated. Upon the instantiation of the target version of the CO-PLAY application, the source CO-PLAY application will provide only user input signals which will be sent via the communication channel 347 to the instantiated remote target where the remote application will interpret those instructions 348 and execute the application in a more robust manner. For example, a game using an iPhone as a controller, e.g., iGolf, may have a more robust version of iGolf loaded on a target laptop, and as such, take the accelerometer inputs of an iPhone source device to direct the execution of the game on the target device.

In one embodiment, when IPDT application is engaged, the source device may transmit control information and data payloads to the target device in a variety of data formats. FIG. 4 illustrates examples of data formats transmitted from the source device to the target device within embodiments of the IPDT operation. In one implementation, the source device may send data to a processor-based target device via a binary data packet 402, which includes fields such as message type 405, sequence number 406 acknowledgement number 407, data offset 408, data length 409, checksum 410, options 411 and data payload 412 and/or the like. The data 412 may include, but not limited to accelerometer information, pointer coordinates (pressing on the screen), images, GPS information, user information, and/or the like. For example, in one implementation, the data 412 may take a form similar to, a 64-byte user information field, including user ID, device ID etc., a 96-byte accelerometer information, including 3-dimentional coordinates (x, y, z), a 64-byte latitude/longitude value, a 64-byte pointer coordinate value (x,y), a 32-byte image length value, and data with variable lengths such as image raw data, video time information, and/or the like. In one embodiment, the image raw data may be generated and sent in compliance with the VNC video transport data format and/or a pointer to separate VNC video transport data stream. In one embodiment, the pointer may point to a .vnc file on the file system, or may incorporate the contents of such a file such that it specifies host, port, password, options (e.g., bit depth, mouse settings, scale, emulation, clipboard, etc.), and extensions such as sessions. In one embodiment, Remote Framebuffer Protocol (RFB) may be used as may be seen in: The Remote Framebuffer Protocol, Tristan Richardson (Real/NC Ltd), Oct. 26, 2009, <http://www.realvnc.com/docs/rtbproto.pdf>; and at Display Filter Reference: Virtual Network Computing <http://www.wireshark.org/docs/dfref/v/vnc.html>; both of which are hereby expressly incorporated by reference.

In another implementation, the source device and the target device may exchange data via a Common Object Request Broker Architecture (CORBA 420) mechanism. For example, the source device and the target device may define a series of objects, such as, but not limited to accelerometer which may contain information regarding accelerometer status, GPS which may contain information about the device location, pointer which contains information about the user interaction on the screen, screen which contains the screen stream, and/or other data structure which may contain various data streams and constructs pertaining to a given application. In one implementation, the source device 422 as a host may interface with object structure 425, object Class Structure 427 running on an object requested broker 429, and communicate with client target 445 via a network connection 430. The client target may implement a specified object 440, object skeleton code 437 running on the target device side object requested broker 435. For example, in one implementation, the C++ implementation for defining data object under CORBA may take a form similar to the following:

//Define Accelerometer Data Object
class AccelerometerDataService :
public PortableServer::RefCountServantBase
{
public:
AccelerometerDataService( );

virtual ~AccelerometerDataService( );
virtual CORBA::Boolean Update( CORBA::Long x,

CORBA::Longy,

CORBA::Longz);

};
′
...
CORBA::Boolean AccelerometerDataService::Update (

```
  CORBA::Long x,
  CORBA::Long y,
CORBA::Long z)
```

{

return true;

}

In one example, the C++ implementation for connecting to the server under CORBA may take a form similar to the following:

//Connecting to the Server

...

CORBA_ORB_var orb=CORBA_ORB_init(argc, argv);
const char* refFile=“AccelerometerDataService.ref”;
ifstream in;
in.open(refFile);
CORBA_Object_var obj=orb−>string_to_object(s);
AccelerometerDataServiceads =
AccelerometerDataService::_narrow(obj);

ads−>update(x,y,z);

...

FIG. 5A illustrates aspects of an interactive proximity display tether with co-play within one embodiment of the CO-PLAY. As shown in FIG. 5A, a source device 550 (e.g., a smart mobile device, etc.) may establish a communication path with target device 551 (e.g., a television, a desktop, a laptop, etc.) across communications network 555, such as, but not limited to Bluetooth, 3G network, WiFi, Ethernet, and/or the like. In some implementations, target device 551 may be connected via cable 557 to display device 553 and configured to push the target display data to the display device. Otherwise, target device 551 may display CO-PLAY data on the target's display or in combination with the display device 553 as a dual monitor implementation.

In one embodiment, the source device 550 may tether with the target device 551 as discussed in FIGS. 3A-3C. In one implementation, depending on the processing capabilities of target 551, the source device 550 may drive communications/processing implementing server functionality, while pushing data for display to the target device 551 which would facilitate client functionality for CO-PLAY.

In an alternative implementation, the source device 550 may be able to offload data processing functionality to the target device 551, which could facilitate server functionality. In that case, the source device 550 would facilitate client functionality, whereas the target device 551 would facilitate server functionality for CO-PLAY. For example, in one implementation, a user may engage a gaming application on an Apple iPhone as the source device and project the gaming visualization to the screen of a desktop as the target device. For another example, the gaming application may be engaged on the target device (e.g., a laptop), and the user may operate the source device (e.g., a gameboy) as a remote control to interactively control the game.

In one embodiment, a second mobile device (e.g., a second smart mobile device, etc.) may be incorporated into the CO-PLAY. In one implementation, the source device 550 may establish a communication path via a communications network 556 (e.g., Bluetooth, 3G network, WiFi, Ethernet, etc.) to include a client device 552. Once the communications path is established, client device may be configured to sense user manipulation of the device and transmit the data across the communications network 556 to the source device 550. If the source device 550 is facilitating server functionality, the source device 550 may process the data from client device 552 and forward to the target device 551 for display. On the other hand, if source device 550 is facilitating client functionality with the target device 551 facilitating server functionality, the source device 550 may act as a conduit to relay the user manipulation data from the client device 552 to the target device 551.

In one embodiment, the CO-PLAY may be configured to facilitate the client device 552 and the source device 550 interacting in an interactive gaming platform that is displayed by target device 551 or display device 553. For example, in a one implementation, the user interactions with respective devices 550 and 552 may be displayed in realtime in an iGolf, iTennis or similar interactive co-play games, represented by first and second avatars 558 and 559, respectively.

FIG. 5B illustrates aspects of an interactive proximity display tether with co-play within an alternative embodiment of the CO-PLAY. In one embodiment, instead of the client device 562 establishing a communication path and communicating with the CO-PLAY through the source device 560, the client device 562 establishes a communication path and communicates with the CO-PLAY directly through target device 561 across communications network 566 after source/target device client/server functionality has been established. In one implementation, the CO-PLAY in FIG. 5B will facilitate the client device 562 and source device interacting in the gaming platform that is displayed by the target device 561 or display device 563.

FIG. 5C illustrates aspects of an interactive proximity display tether with co-play within another alternative embodiment of the CO-PLAY. In one embodiment, client device 572-A may join the Co-play IPDT by first connecting with client device 572-B across communications network 576 which in turn may join with target device 371 to achieve CO-PLAY. In one embodiment, target device 571 facilitates server functionality and as such, drives the processing of user inputs from source device 570, and client devices 572-A/572-B. Once the client device data is processed by target device 571, target device 571 may display persistent platform gameplay on its display and/or via a tethered display 574A. In some instances, target device 571 may also transmit display data back to client device 572B for display on the client device 572B or tethered display 573B.

FIG. 5D illustrates aspects of an interactive proximity display tether with co-play within another alternative embodiment of the CO-PLAY. In one embodiment, target device 581 facilitates client functionality instead of server functionality, which is facilitated by source device 580 in this implementation. As such, to source device 580 receives and processes user interaction data from source device 580, as well as client device 582A via communication networks 584, 585, and 586 communicated through client devices 582B and 581. Once received, source device 580 processes and serves the processed user interaction data back to target 581 and client 582B for display.

The CO-PLAY facilitate significant flexibility and may be configured in a wide variety of implementations. Although a few example implementations are discussed herein to facilitate understanding the features achieved by CO-PLAY, it is to be understood that this disclosure contemplates variations of the various example implementations explicitly described herein. Further, although the examples described herein discuss implementations with two mobile devices and one or two laptops, it is to be understood that CO-PLAY implementations may be configured to facilitate communication between more than two client devices. It should be further noted that disparate devices may engage in co-playing. e.g., a gameboy co-play session with an iPhone, a PSP co-play session with a Google Android, etc.

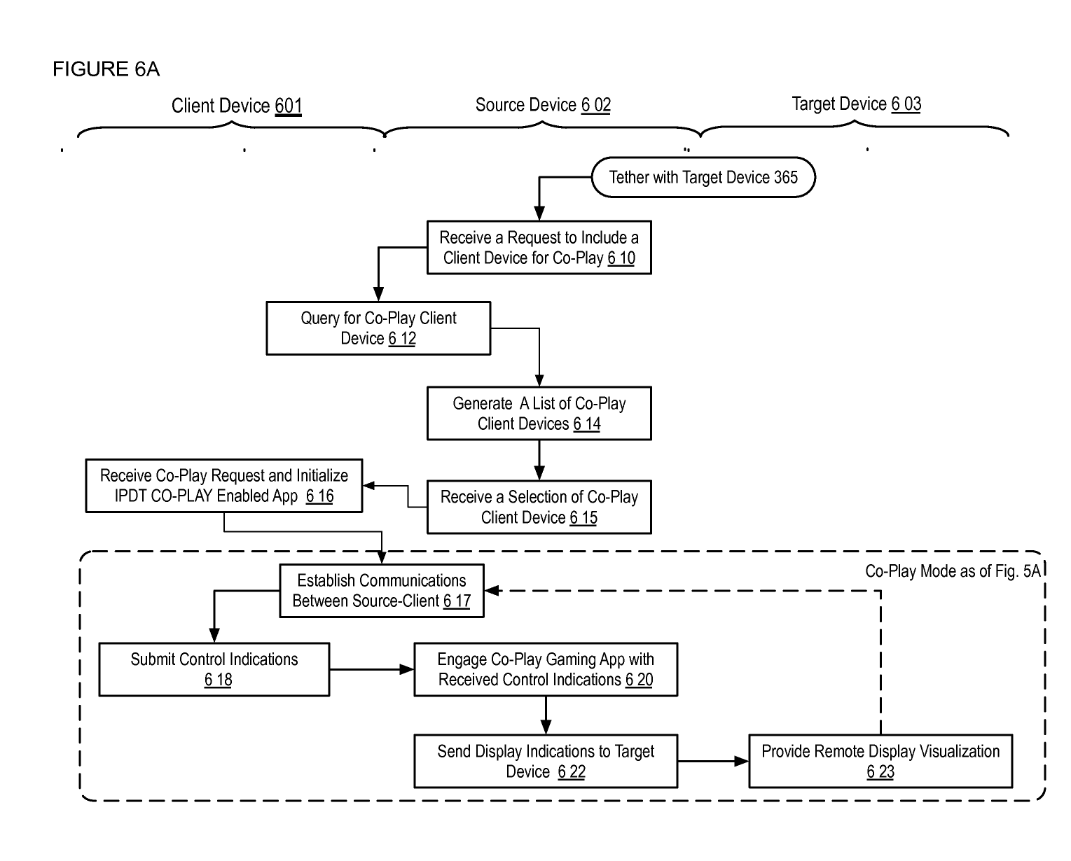

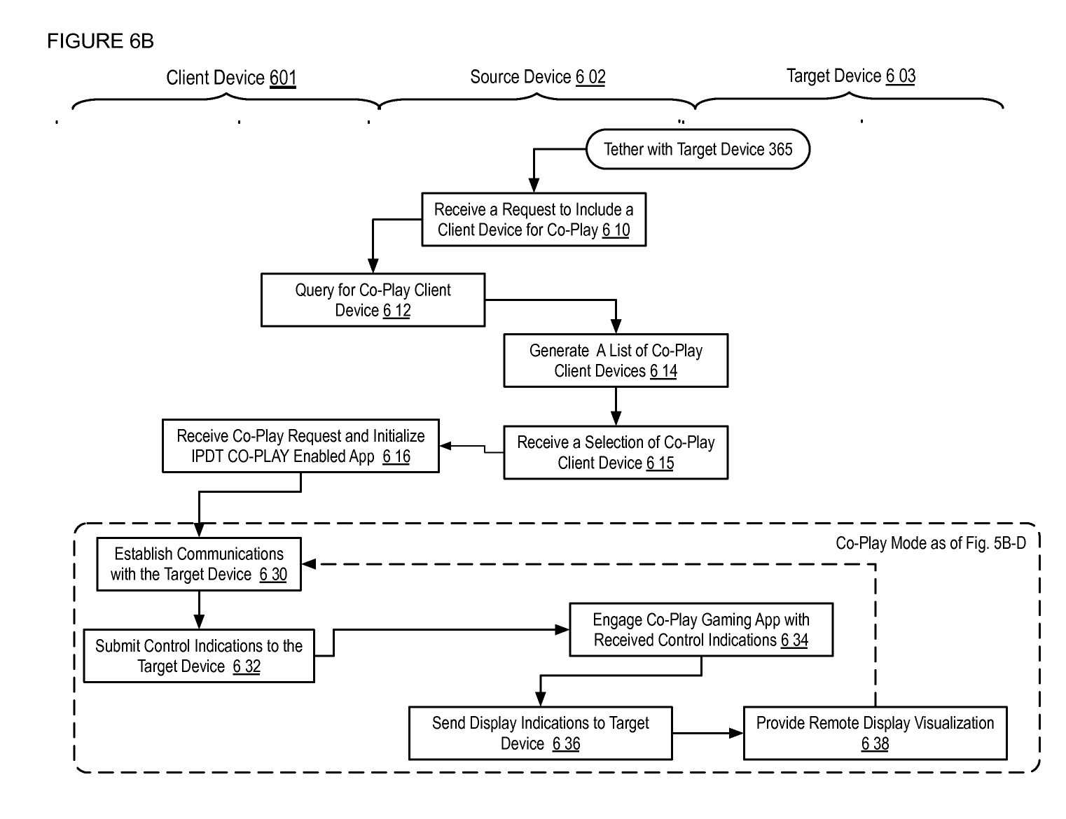

FIG. 6A provides an overall logic flow illustrating aspects of incorporating a co-play client device in one embodiment of the CO-PLAY. In one embodiment, a source device 602 may tether with a target device 603 as discussed in FIGS. 3A-C. In one embodiment, the source device may receive a request to include a client device for co-play 610. For example, a user may engage in a gaming platform that requires at least two players and then select a “co-play” mode from the gaming menu. For example, in one implementation, two palyers may each engage the Apple iPhone game “Fleet Air Superiority Training” (F.A.S.T.) application on their iPhone to co-play the game
In one embodiment, the source device may query for a co-play client device 612. In one implementation, the sensing and detecting for client device may be implemented in a similar manner as the query for a target device during a tethering process as discussed in FIG. 3B. For example, in one implementation, the CO-PLAY source device 602 may search for a co-play device based on user submitted information such as, but not limited to known IP address, MAC address, acronym, hardware label, digital signature, driver certificate, zero-configuration information, and/or the like of a potential co-play client device. For another example, in an alternative implementation, the CO-PLAY source device may query the communication stack in the hardware database for registered devices/communication channels that are compatible with the source device. For another example, in an alternative implementation, the CO-PLAY source device may start a search to locate suitable co-play devices within a range of local area network by zero configuration protocols such as, but not limited to Service Location Protocol (SLP), Universal Plug and Play (UPnP), Jini, Bluetooth Service Discovery Protocol, WS-Discovery, Proprietary Discovery Protocol, Bonjour and/or the like. In such an implementation, a co-play client device may broadcast its availability and publish a server via a zero-configuration network, e.g. an Apple SDK may be used to create a Bonjour service.

In one embodiment, the CO-PLAY may generate a list of available co-play client devices 614, and present the list to a user via a user interface. In one embodiment, the CO-PLAY may receive a selection of co-play client device 615, and then send a request to the selected client device. The client device 602 may sense the co-play request (e.g., by receiving a co-play request message via zero-configuration conduit) and initialize a CO-PLAY enabled application 616. For example, in one implementation, the client device 601 may provide a pop-up window on screen displaying the received request to co-play. Upon receiving an affirmative indication, the client device may then initialize the co-play component.

In one embodiment, the CO-PLAY may establish a communications channel between the client device and the source device 617, as discussed in FIG. 5A. The client device may then send control indications 618 to the source device. In one implementation, the source device and the client device may be connected via a wired cable such as a dock connector cable that is directly plugged in the mobile device, or wireless network, such as Bluetooth, 3G, Wi-Fi and/or the like.

In one implementation, the CO-PLAY may receive and integrate control indications from both the client device and the source device to engage the gaming application. For example, in one implementation, a user may engage the client and or the source device as a remote control, such as a gameboy, etc., and input control commands via a user interface (e.g., mouse, keyboard, etc.). For another example, a user may engage a CO-PLAY remote control device housing in an emulating equipment, such as a golf club, a tennis racquet and/or the like. The user may swing the remote control device as if swinging a real golf club or tennis racquet in field, and the sensor of the client or the source device may detect signals of the motion of the club or racquet and transfer the signals (e.g. electrical pulses from accelerometers indicating a velocity and a direction of a swing, etc.). The client or source device may process and analyze the received signals and generate data describing characteristics of the movement, e.g. direction of the movement, speed of the movement, motion level, etc., and transmit the data to the CO-PLAY. For example, in one embodiment, the iPhone SDK toolkit and/or runtime libraries may be installed and/or used to access, obtain such inputs, and interpret such actions.

In one implementation, the communications between the client device and the source device may be supported by a method-call semantics mechnism, e.g., CORBA, as discussed in FIG. 4. For exmaple, in one implementation, the gaming application runnning on the source device may interface an object request borker of a CORBA infrastructure to invoke a remote object on the gaming application running on the client device, e.g., each co-player is defined as an object. In one implementation, an example 22C/C++ implementation of defining a player object (a source device or a client device) in the F.A.S.T. gaming platform, may take a form similar to:

struct Player
{

| | |
|---|---|
| Peer *peer; | //client listening server port |
| bool | ready; // ready state |
| int8 | plane; // plane index |
| char | name[32]; // client name |
| Plane | *airplane; |
| bool | isDisconnected; // Player disconnected |

| | |
|---|---|
| int | kills; |
| int | deaths; |
| int8 | team; |
| int | ranking; |
| int | rankPosition; |
| int | rankIfwin; |
| int | rankIfLose; |
| int | ranksPerTeam[4]; |

};

In one embodiment, the CO-PLAY source device may send display indications to the target device 622, and display an enlarged gaming visualization on the screen of the target device 623 in a real-time manner via the established tethering between the source device and the target device.

FIG. 6B provides an overall logic flow illustrating aspects of incorporating a co-play client device in an alternative embodiment of the CO-PLAY. For example, in one implementation, upon receiving a selection of co-play client device, instead of establishing communications between the source device and the client device, the CO-PLAY client device may directly establish a communications channel with the target device 630. In one implementation, in addition to the implementations described in FIG. 6A for querying for co-play client device 612, the target device may engage as a gaming server to drive the co-play platform and provide a list of available players. For example, in one implementation, both the source device and the client device may access an Internet gaming platform and register with their IP address, MAC address, user account etc., whereby the target device may be a computer connected to the Internet gaming server. In such an implementation, a user may use the web browser running on the source device to navigate to the gaming server on the target device. As such, a user may view a list of co-players published from the target device (the Internet gaming server) available via Wi-Fi.

In one embodiment, a player operating the source device may submit a selection of co-play client device to the target device, and CO-PLAY may establish communications between the target device and the client device 630. In one implementation, the target device may tether with the client device in similar manners as discussed in FIG. 3C. For example, in one implementation, the CO-PLAY client device may tether with the target device via a physical tether, e.g., a direct audio/video connection such as an iPhone Video AV to Dock Connector Cable that is plugged directly into a large television, a Casio XJ-S57 with a WiFi YW-2 adapter connected via WiFi, and/or the like. For another example, in an alternative implementation, the CO-PLAY client device may connect with a secured application server running on or connected to the target device, e.g., a distributed object oriented application, a web server, a remote display client (e.g., citrix, VNC, etc.), a web browser, and/or the like. For another example, in an alternative implementation, the target device may be broadcasting based on a zero-configuration protocol (e.g. Bonjour, SLP, UPnP, Jini, Bluetooth Service Discovery Protocol, WS-Discovery, Proprietary Discovery Protocol, and/or the like) or responding to a proprietary communication request to tether with the client device.

In one embodiment, the client device may directly submit control indications to the target device 632. If the target device acts as the gaming server to drive the co-play platform, the target device may receive control indications from the source device and the client device to engage the co-play gaming application 634. For example, the target device (e.g., a computer, etc.) may obtain and run a gaming application component from the Internet. In an alternative implementation, if the source device acts as the gaming server, the target device may forward the control indications to the source device to engage the co-play gaming application 634.

In one implementation, the source device may send display indications to target device 636 for remote display visualization 638. In an alternative implementation, as shown in FIGS. 5C and 5D, the client device and the source device may tether with different target devices, respectively, and each of the target devices may be connected to a large display (e.g., a television, a projector, etc.) for visualization. In one implementation, the target devices may be connected via a communications network to exchange gaming data in real time. For example, each of two users may is employ a mobile device to tether with a separate computer, respectively, and both of the computers may access an Internet gaming server to engage the users for co-play.

In one implementation, a iPhone SDK application of defining an object of querying and testing reachability of a client device over the network may take a form similar to:

@class Reachability;
@interface Reachability : NSObject {
@private

BOOL _networkStatusNotificationsEnabled;
NSString *_hostName;
NSString *_address;
NSMutableDictionary *_reachabilityQueries;

```
}
...
/*
  When reachability change notifications are posted, the callback method
‘ReachabilityCallback’ is called
  and posts a notification that the client application can observe to learn
about changes.
  */
static void ReachabilityCallback(SCNetworkReachabilityRef target,
SCNetworkReachabilityFlags flags, void *info);
@end
...
@implementation Reachability
@synthesize networkStatusNotificationsEnabled =
_networkStatusNotificationsEnabled;
@synthesize hostName = _hostName;
@synthesize address = _address;
@synthesize reachabilityQueries = _reachabilityQueries;
+ (Reachability *)sharedReachability
```

| | |
|---|---|
| { | ... |
| | // This returns YES if the address 169.254.0.0 is reachable without |

requiring a connection.
− (BOOL)isAdHocWiFiNetworkAvailableFlags:(SCNetworkReachabilityFlags *)outFlags
{

// Look in the cache of reachability queries for one that matches this

query.

ReachabilityQuery *query = [self.reachabilityQueries

objectForKey:kLinkLocalAddressKey];

SCNetworkReachabilityRef adHocWiFiNetworkReachability =

query.reachabilityRef;
...
}
@end

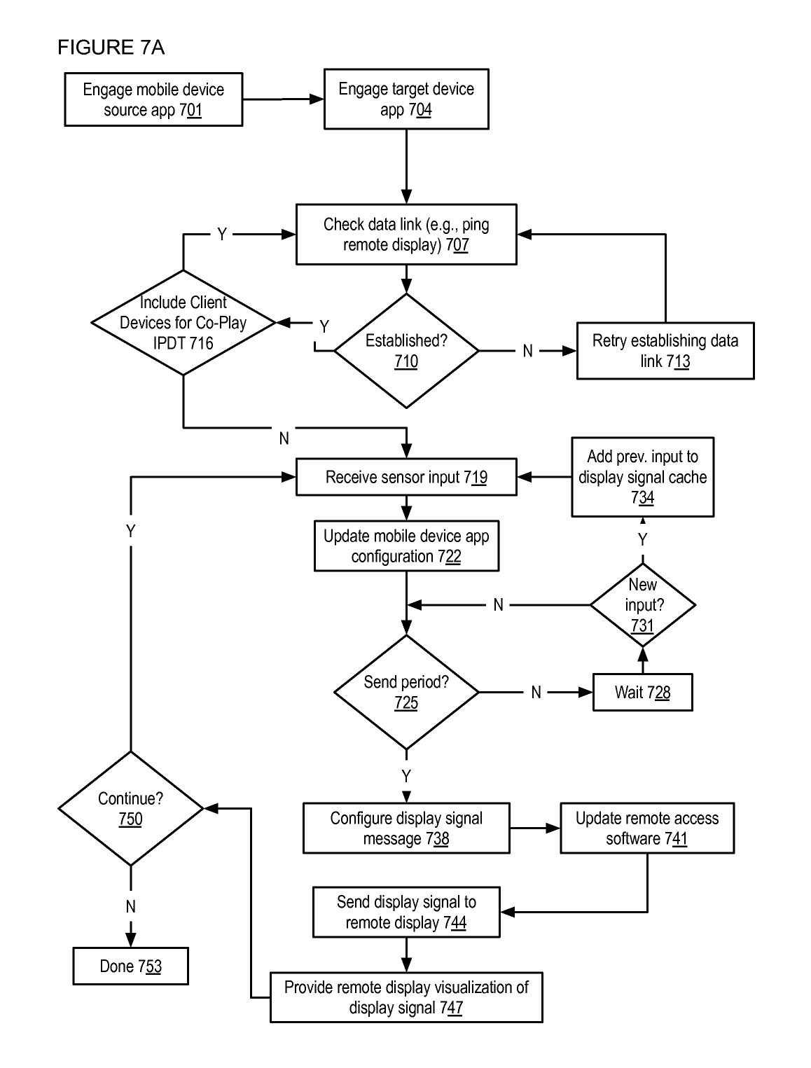

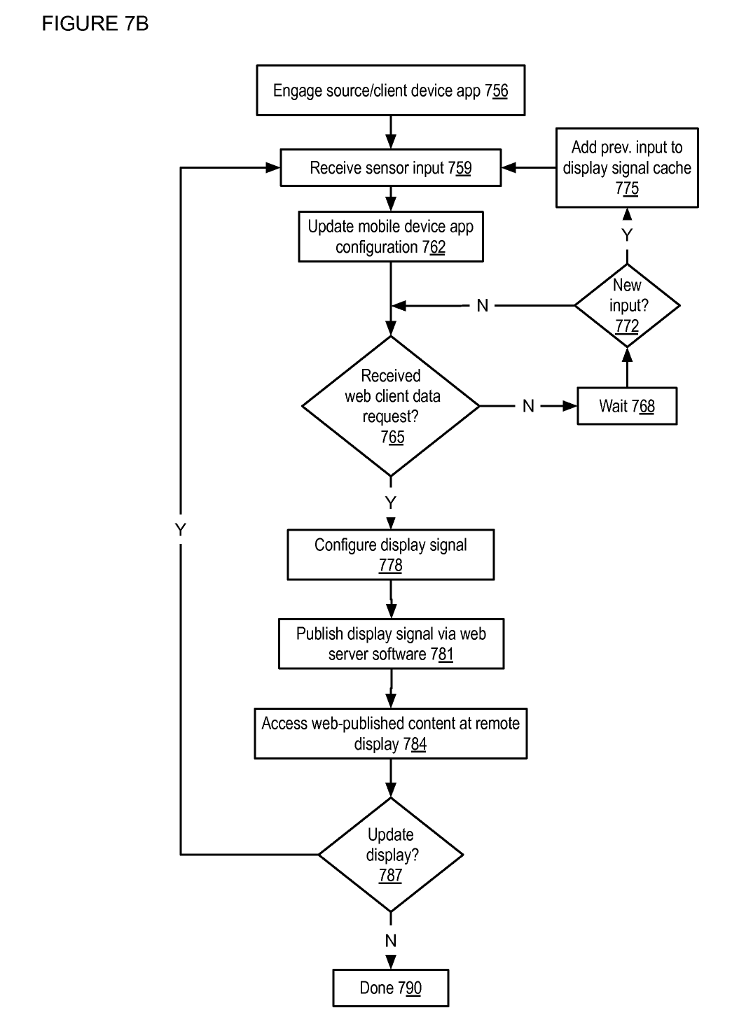

FIG. 7A shows an overall logic flow illustrating CO-PLAY in an alternative embodiment of CO-PLAY operation. The logic flow shown is directed to an alternative embodiment of the CO-PLAY employing remote access software, such as Citrix or VNC, to couple a mobile source device with a target device as a remote display, as well as available client devices. A user may engage a mobile source device application 701, such as by turning on the mobile device, selecting an application icon, and/or the like. In one implementation, both an application and remote access software may be engaged at the mobile source device. A remote display target device application may also be engaged 704, such as by turning on the mobile device, selecting an application (e.g., remote access software), and/or the like. The mobile source device and/or the remote display target device may check for a data link to the counterpart device, such as by pinging the counterpart 707 and a determination may be made as to whether a data link has been established 710. If not, then the mobile source device and/or the remote display target device may retry establishing a data link, such as by repairing and/or refreshing a network connection, presenting an error message via a user interface and requesting that the user check communication components, and/or the like 713.

Once the source device and target establish a viable communications path, the CO-PLAY may check whether additional client devices are available to be incorporated into the CO-PLAY 716. If so, the communication paths are established 707-710. Otherwise, sensor components may receive sensor inputs 719 that may cause user interaction updates to a mobile source device application configuration 722. For example, in one implementation, a sensor input may comprise a state of motion, such as may be detected by an accelerometer. This state of motion may be translated into a virtual state of motion for an avatar or other virtual entity in the context of a mobile device application, such as a video game. A determination may be made at 725 as to whether or not a send period has concluded. If not, then the user's source/client device may wait for a period of time 728 and check whether any new inputs have been received from the sensors 731. If so, then the user device may add the most recent set of sensor inputs and/or corresponding application configurations to a display signal cache 734 and proceed to receive the new sensor inputs 719. Otherwise, the user's source/client device may return to 725 to check whether the send period has concluded. Once a send period has concluded, the user's source/client device may configure a display signal message corresponding to a current and/or set of recent application states 738. For example, in one implementation, the display signal may represent a current and/or set of recent positions and/or states of motions of an avatar in a video game.

In implementation's where the source device facilitates server functionality, the user's source/client device may update remote access software at the source device, such as Citrix, VNC, and/or the like 741, and send the corresponding display signal to the remote display target device 744. The remote display on target device 744, in turn, may provide a visualization of the display signal, such as on a display screen 747. A determination may be made as to whether to continue with Co-play IPDT operation 750. If so, then the user's source/client device transition to receive further sensor inputs 719. Otherwise, the IPDT CO-PLAY is completed 753.

FIG. 7B shows an overall logic flow illustrating CO-PLAY in an alternative embodiment of CO-PLAY operation. The logic flow shown in FIG. 6B is directed to an alternative embodiment of the user's source/client device employing web server software to couple a mobile source device to a remote display target device, such as by publishing mobile device application data to a web site for retrieval by an internet-connected target device. A user may engage a user's source/client device application 756, such as by turning on the mobile source/client device, selecting an application icon, and/or the like. In one implementation, both an application and web server software may be engaged at the mobile device. The user's source/client device's sensor components may receive sensor inputs 759 that may cause updates to a mobile device application configuration 762. A determination may be made at 765 as to whether or not a web client data request, such as an HTTP request, has been received. If not, then the user's source/client device may wait for a period of time 768 and check whether any new inputs have been received from the sensors 772. If so, then the user's source/client device may add the most recent set of sensor inputs and/or corresponding application configurations to a display signal cache 775 and proceed to receive the new sensor inputs 759. Otherwise, the user's source/client device may return to 765 to check whether a web client data request has been received. In an alternative implementation, the user's source/client device may send display signals to a target device without regard to whether a web client data request has been received or not. In this implementation, the user's source/client device may send display signals to an intermediary repository. The repository, then, may monitor the receipt of web client data requests and provide one or more current or historical display signals to the web client supplying the data request.

Once a web client data request has been received, the user's source/client device may configure a display signal message corresponding to a current and/or set of recent application states 778. The configured display signal may be published on the World Wide Web via web server software 781. The published application state content may then be accessed by one or more remote display target devices, such as by accessing a web site on which the application state data is hosted 784. In one implementation, application state data may be represented on a website as an integrated video, animation, rich Internet application, and/or the like configured in accordance with a multimedia plug-in such as Adobe Flash. A determination may be made at 787 as to whether to update the displayed visualization of the application state at the remote display. If so, then additional sensor inputs are received at 759. Otherwise, the CO-PLAY session concludes 790.

FIG. 8A-8C provide examples of screenshots from an Apple iPhone F.A.S.T. gameplay platform illustrating aspects of a CO-PLAY gaming application within a CO-PLAY operation. In FIG. 8A, a user may be provided options to launch a CO-PLAY gaming application 870, and upon choosing the “competition,” the user may be presented a list of gaming connection options 872. In one embodiment, if the user chooses “Bluetooth,” the CO-PLAY may search for another iPhone or other tether target devices via Bluetooth network 873, and present a list of available co-play client devices (and/or tether target) to the user 875. The user may then select a client device 878 for co-play and connect with the tether target 880. Upon establishing connection with the is client device (in this case another iPhone), the CO-PLAY application may be engaged on both the source device and the client device 882 and 883 to facilitate co-play.

In one embodiment, as illustrated in FIG. 8B, if the user chooses “lobby list” in the “competition” menu 872, the CO-PLAY may provide a list of available “lobbies” on a gaming host server 874. Upon user's selection of a lobby, the IPDT may connect to a host server 876/878 and load the video game on the user device 882/883. In another embodiment, as illustrated in FIG. 8C, if the user selects “market” at 870, the CO-PLAY application may provide gaming features for sale 386. In another embodiment, if the user selects “social” at 870, the CO-PLAY application may provide an option to publish the gaming feeds of the user via social media (e.g. through Facebook, etc.) 888.

FIGS. 8D-8F provide examples of screen shots from an Apple iPhone iTennis gameplay platform illustrating aspects of a CO-PLAY gaming application within a CO-PLAY operation. For example, in one implementation, a user may launch an iTennis application on an iPhone, and view a list of available games. In one implementation, the user may search for available games 850 by entering the name of the game, and/or a co-player's name. In FIG. 8E, a list of available players in the “booth” 860 is shown to the user upon user selection of a game. In one implementation, the list may also indicate whether an active player is iPhone connected or not 855/862. In one implementation, a user may configure the game to be public or private 865, i.e., whether the engaged game may be viewed by other active players outside the game. In one implementation, the CO-PLAY may provide a list of friends of the user 864, and allow a user to search for a friend 863 based on friend information, such as player name, etc. FIG. 8F shows an example screen shot of avatars of two players co-playing an iTennis game in one embodiment of a CO-PLAY operation.

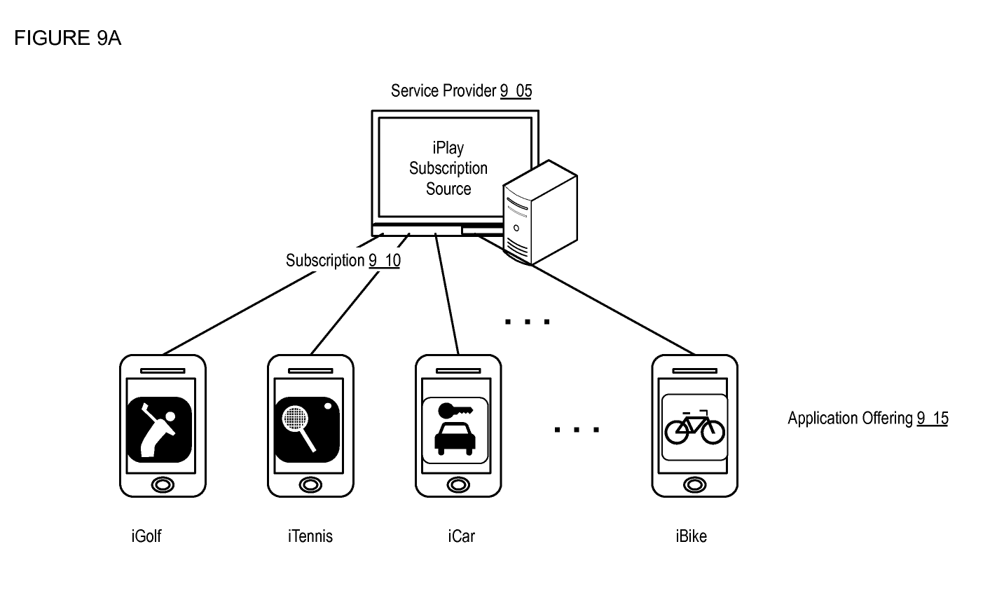

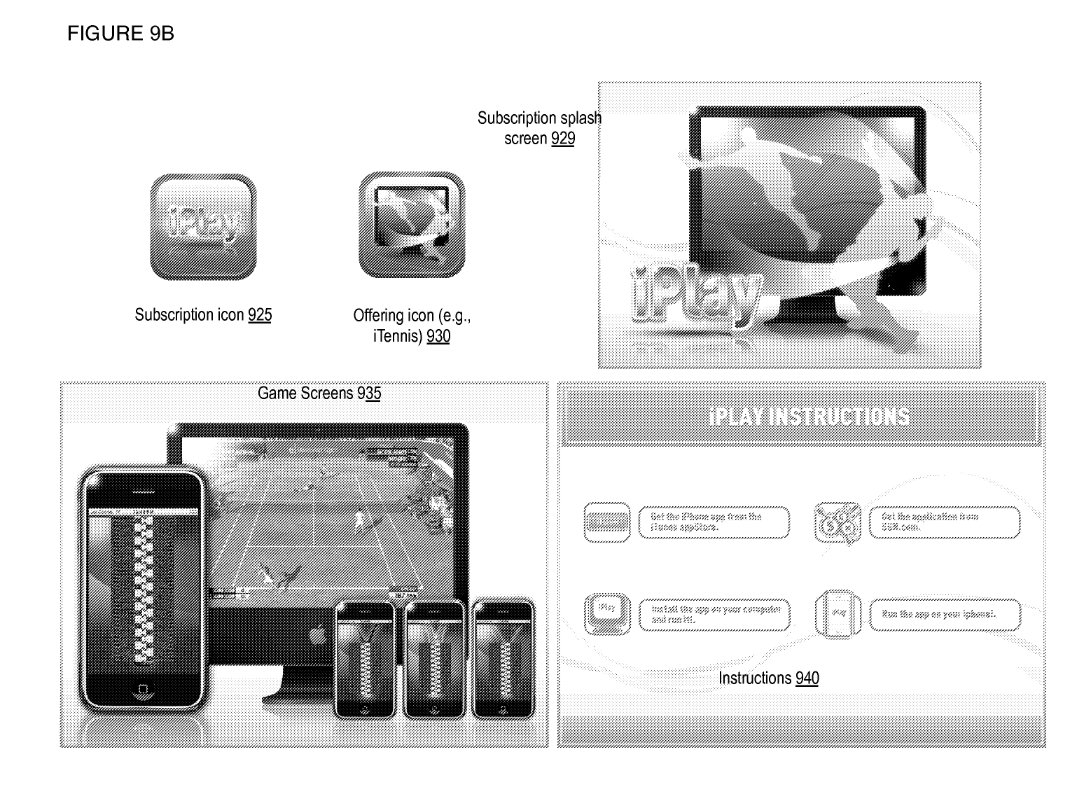

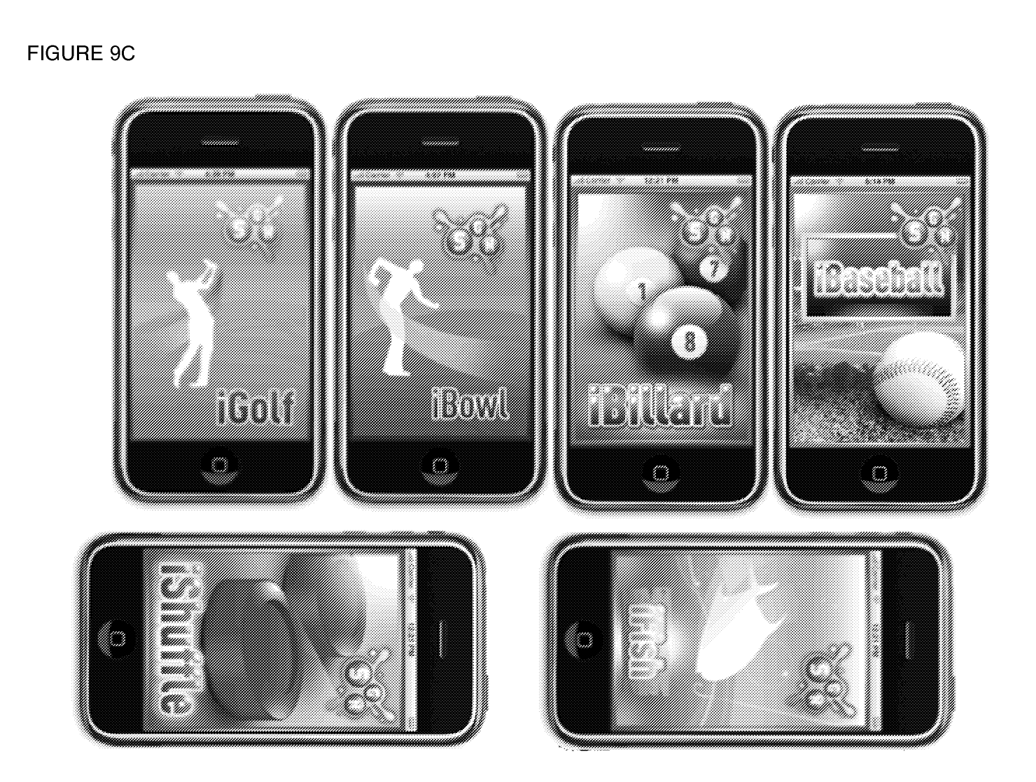

FIG. 9A is of a block diagram illustrating a CO-PLAY payment model. In one embodiment, a central service 905 may provide offering applications 915 via a subscription 910 or on any individual purchase basis. For example, offerings that otherwise may need to be purchased for a set price (e.g., $1.99 for each application) via a service such as the Apple App Store or may otherwise be accessed via a subscription service. In one embodiment, a service application may be downloaded onto the source device. Service applications once purchased may act to download games/offerings 920 free of charged for specified periods of time based on key sets. For example, the purchase date of the service application 905 may be used as a basis of providing offerings 915. For example, if the service application (e.g., iPlay) is purchased via the App Store on Jan. 1, 2009, where the version of iPlay purchased is a 1 year subscription (e.g., for $19.99), then any offerings obtained up until Jan. 1, 2010 will work accessing an authorization key within the iPlay application, that key expiring at the end of the year.

FIG. 9B is of a block diagram illustrating a CO-PLAY screens. In one embodiment, the subscription model may be wrapped in its own application 925 and execute as a full application on the source device 929 including icons and splash screens. Offerings, e.g., iTennis, 930 in a subscription model will work as full applications with instructions 940 and game screens. Locked versions of the offerings may have a zippered appearance 935 when out of subscription, which may be unlocked under a renewed subscription.

### Interactive Extensions

Another advantage to the CO-PLAY involves features that may extend interaction with applications. Such extensions are particularly useful in the areas of electronic gaming. For example, when a source device, e.g., an iPhone, is tethered to a target device, e.g., a large screen computer, the source device may then become a game controller input device relaying game data/instructions to the target device as it casts its display information across the communications tether. For example, a user may use an iPhone as an analogue to a tennis racquet, playing a virtual game of tennis via an iTennis application offering that is facilitated with a CO-PLAY component. Beyond using the iPhone as a tennis racquet handle for swinging the racquet, where the iPhones 3D accelerometers may be measured to obtain the dynamics of the string, the CO-PLAY can further extend features by employing the touch screen. For example, in one embodiment, a user can pinch the virtual tennis strings on the racquet together as they swing the iPhone to get an extra power boost in the game. Further, a user may use multitouch gestures to tighten or loosen the strings on the racquet, which will be used as additional input for the CO-PLAY application and will affect the dynamics of the game (e.g., loosened strings increasing power but decreasing accuracy).

Additionally, the CO-PLAY may be used to house user (e.g., game) profiles and progress. In this manner, user avatars and accounts such as (e.g., iMe) may be accessed on the source device even if the target device is unable and/or has no capacity to connect to the internet or otherwise gain access to the users profiles. In one embodiment, the profiles are mirrored and/or cached onto the source device, e.g., the iPhone, from a service on the internet. These settings may be transferred to the target device and/or accessed across the tether. Furthermore, such avatars and settings may be used to interact with other CO-PLAY application offerings. For example, two or more source devices, e.g., iPhones, from two different users may be simultaneously tethered onto a single target device and allowed to share a singular application space on the target application. For example, one of the two source devices can act as a host application and accept communication with the other source device. Thus, in one embodiment, where each user has a virtual avatar, the two avatars may be controlled in a common space on the target display simultaneously. Further, such an impromptu target virtual space may be the source for transactions between the parties: e.g., the avatars may trade valuable digital assets such as digital cash for digital objects (e.g., gold coins for enhanced game weapons and/or devices). In one embodiment, a common multiplayer display housing all the source, e.g., iPhone, players may be seen on the single target device, but the displays of the source devices may have another view that is private to each users. In such an embodiment, users may interact in a common area on the target display and engage in secondary and/or private/secret strategic activities on their own personal displays.

In another embodiment, a single target display, like a large computer display or television would allow two or more players play high action games like ping-pong or tennis. In another embodiment, the CO-PLAY allows the source device to turn most any target device into an impromptu presentation display device.

FIG. 9C shows aspects of different applications of a CO-PLAY in one embodiment. These may include, but are not limited to, games such as golf, bowling, billiards, baseball, shuffleboard, fishing, and/or the like.

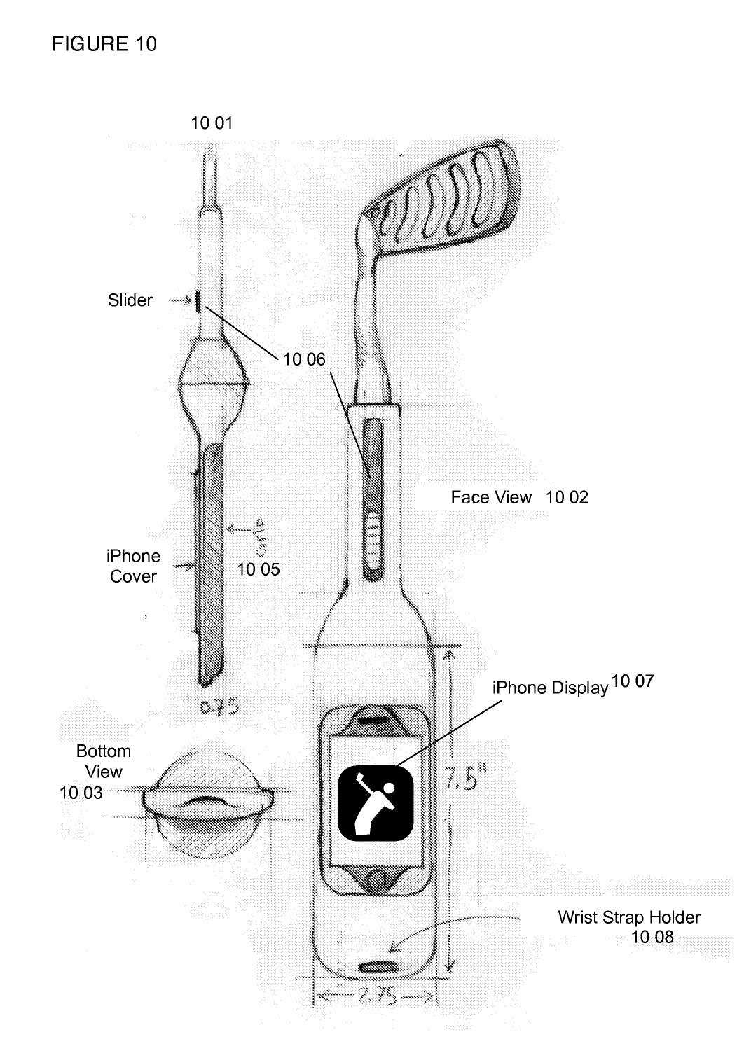

FIG. 10 show implementations of a CO-PLAY housing configured as a golf club in one embodiment. A mobile device such as an Apple iPhone may be secured in a housing shaped as a gaming implement, such as a golf club for a golf game, tennis racket for tennis game, fishing pole for a fishing game, baseball bat for a baseball game, and/or the like. As shown in FIG. 10, in one implementation, 1001 provides a profile view of the gold club, which includes a grip coating with rubber, plastic 1005 and/or the like. The golf club also has a retracting extendible body with a slider 1006, as shown in the face view 1002. The golf club grip may also provide an iPhone cover to place an iPhone 1007, wherein the grip may have an example size of 7.5 inches by 2.75 inches. At the bottom of the golf club, a wrist strap holder 1008 may be provided, as shown in the face view 1002 and the bottom view 1003.

### CO-Play Controller

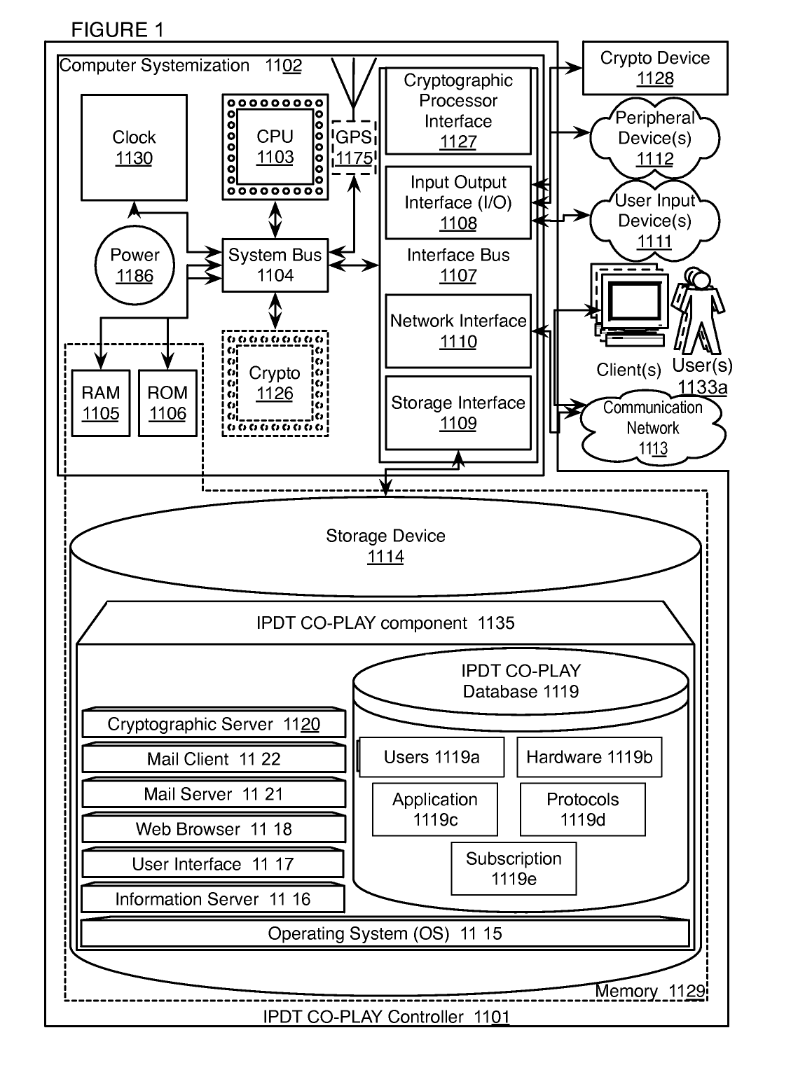

FIG. 11 illustrates inventive aspects of an CO-PLAY controller 1101 in a block diagram. In this embodiment, the CO-PLAY controller 1101 may serve to aggregate, process, store, search, serve, identify, instruct, generate, match, and/or facilitate interactions with a computer through real time control and resource sharing technologies, and/or other related data.

Typically, users, which may be people and/or other systems, may engage information technology systems (e.g., computers) to facilitate information processing. In turn, computers employ processors to process information; such processors 1103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the CO-PLAY controller 1101 may be connected to and/or communicate with entities such as, but not limited to: one or more users from user input devices 1111; peripheral devices 1112; an optional cryptographic processor device 1128; and/or a communications network 1113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CO-PLAY controller 1101 may be based on computer systems that may comprise, but are not limited to, components such as: a computer systemization 1102 connected to memory 1129.

### Computer Systemization

A computer systemization 1102 may comprise a clock 1130, central processing unit (“CPU(s)” and/or “processor(s)” (these terms are used interchangeable throughout the disclosure unless noted to the contrary)) 1103, a memory 1129 (e.g., a read only memory (ROM) 1106, a random access memory (RAM) 1105, etc.), and/or an interface bus 1107, and most frequently, although not necessarily, are all interconnected and/or communicating through a system bus 1104 on one or more (mother)board(s) 1102 having conductive and/or otherwise transportive circuit pathways through which instructions (e.g., binary encoded signals) may travel to effect communications, operations, storage, etc. Optionally, the computer systemization may be connected to an internal power source 1186. Optionally, a cryptographic processor 1126 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the CO-PLAY controller and beyond through various interfaces. Should processing requirements dictate a greater amount speed and/or capacity, distributed processors (e.g., Distributed CO-PLAY), mainframe, multi-core, parallel, ie and/or super-computer architectures may similarly be employed. Alternatively, should deployment requirements dictate greater portability, smaller Personal Digital Assistants (PDAs) may be employed.

Depending on the particular implementation, features of the CO-PLAY may be achieved by implementing a microcontroller such as CAST's R8051XC2 microcontroller; Intel's MCS 51 (i.e., 8051 microcontroller); and/or the like. Also, to implement certain features of the CO-PLAY, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the CO-PLAY component collection (distributed or otherwise) and/or features may be implemented via the microprocessor and/or embedded components; e.g., via ASIC, coprocessor, DSP, FPGA, and/or the like. Alternately, some implementations of the CO-PLAY may y be implemented with embedded components that are configured and used to achieve a variety of features or signal processing.

Depending on the particular implementation, the embedded components may include software solutions, hardware solutions, and/or some combination of both hardware/software solutions. For example, CO-PLAY features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the CO-PLAY features. A hierarchy of programmable interconnects allow logic blocks to be interconnected as needed by the CO-PLAY system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the CO-PLAY may be developed on regular FPGAs and then migrated into a fixed version that more resembles ASIC implementations. Alternate or coordinating implementations may migrate CO-PLAY controller features to a final ASIC instead of or in addition to FPGAs. Depending on the implementation all of the aforementioned embedded components and microprocessors may be considered the “CPU” and/or “processor” for the CO-PLAY.

### Power Source

The power source 1186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1186 is connected to at least one of the interconnected subsequent components of the CO-PLAY thereby providing an electric current to all subsequent components. In one example, the power source 1186 is connected to the system bus component 1104. In an alternative embodiment, an outside power source 1186 is provided through a connection across the I/O 1108 interface. For example, a USB and/or IEEE 1394 connection carries both data and power across the connection and is therefore a suitable source of power.

### Interface Adapters

Interface bus(ses) 1107 may accept, connect, and/or communicate to a number of interface adapters, conventionally although not necessarily in the form of adapter cards, such as but not limited to: input output interfaces (I/O) 1108, storage interfaces 1109, network interfaces 1110, and/or the like. Optionally, cryptographic processor interfaces 1127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1109 may accept, communicate, and/or connect to a a number of storage devices such as, but not limited to: storage devices 1114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1110 may accept, communicate, and/or connect to a communications network 1113. Through a communications network 1113, the CO-PLAY controller is accessible through remote clients 1133b (e.g., computers with web browsers) by users 1133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed CO-PLAY), architectures may similarly be employed to pool, load balance, and/or otherwise increase the communicative bandwidth required by the CO-PLAY controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1110 may be used to engage with various communications network types 1113. For example, multiple network interfaces may be employed to allow for the communication over broadcast, multicast, and/or unicast networks.

Input Output interfaces (I/O) 1108 may accept, communicate, and/or connect to user input devices 1111, peripheral devices 1112, cryptographic processor devices 1128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1111 may be card readers, dongles, finger print readers, gloves, graphics tablets, joysticks, keyboards, mouse (mice), remote controls, retina readers, trackballs, trackpads, and/or the like.

Peripheral devices 1112 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the CO-PLAY controller may be embodied as an embedded, dedicated, and/or monitor-less (i.e., headless) device, wherein access would be provided over a network interface connection.

Cryptographic units such as, but not limited to, microcontrollers, processors 1126, interfaces 1127, and/or devices 1128 may be attached, and/or communicate with the CO-PLAY controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1129. However, memory is a fungible technology and resource, thus, any number of memory embodiments may be employed in lieu of or in concert with one another. It is to be understood that the CO-PLAY controller and/or a computer systemization may employ various forms of memory 1129. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1129 will include ROM 1106, RAM 1105, and a storage device 1114. A storage device 1114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1129 may contain a collection of program and/or database components and/or data such as, but not limited to: operating system component(s) 1115 (operating system); information server component(s) 1116 (information server); user interface component(s) 1117 (user interface); Web browser component(s) 1118 (Web browser); database(s) 1119; mail server component(s) 1121; mail client component(s) 1122; cryptographic server component(s) 1120 (cryptographic server); the CO-PLAY component(s) 1135; and/or the like (i.e., collectively a component collection). These components may be stored and accessed from the storage devices and/or from storage devices accessible through an interface bus. Although non-conventional program components such as those in the component collection, typically, are stored in a local storage device 1114, they may also be loaded and/or stored in memory such as: peripheral devices, RAM, remote storage facilities through a communications network, ROM, various forms of memory, and/or the like.

### Operating System

The operating system component 1115 is an executable program component facilitating the operation of the CO-PLAY controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the CO-PLAY controller to communicate with other entities through a communications network 1113. Various communication protocols may be used by the CO-PLAY controller as a subcarrier transport mechanism for interaction, such as, but not limited to: multicast, TCP/IP, UDP, unicast, and/or the like.

### Information Server

An information server component 1116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CO-PLAY controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CO-PLAY database 1119, operating systems, other program components, user interfaces, Web browsers, and/or the like.

Access to the CO-PLAY database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CO-PLAY. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CO-PLAY as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HYFPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the CO-PLAY enabled nodes. The combined application may be nugatory on systems employing standard Web browsers.

### Mail Server

A mail server component 1121 is a stored program component that is executed by a CPU 1103. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the CO-PLAY.

Access to the CO-PLAY mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1122 is a stored program component that is executed by a CPU 1103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1120 is a stored program component that is executed by a CPU 1103, cryptographic processor 1126, cryptographic processor interface 1127, cryptographic processor device 1128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the CO-PLAY may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the CO-PLAY component to engage in secure transactions if so desired. The cryptographic component facilitates the secure accessing of resources on the CO-PLAY and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The CO-PLAY Database

The CO-PLAY database component 1119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CO-PLAY database may be implemented using various standard data-structures, such as an array, hash, (linked) list, struct, structured text file a (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the CO-PLAY database is implemented as a data-structure, the use of the CO-PLAY database 1119 may be integrated into another component such as the CO-PLAY component 1135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated. In one embodiment, the database component 1119 includes several tables 1119a-e. In one embodiment, the database component 1119 includes several tables 1119a-e. A Users table 1119a may include fields such as, but not limited to: user_ID, user_name, user_password, contact_info, hardware_ID, payload history, user evaluation and/or the like. A Hardware table 1119b may include fields such as, but not limited to: hardware_ID, hardware_type, hardware_name, data_formatting requirements, protocols, addressing_info, usage_history, hardware_requirements, user_ID, and/or the like. An Application table 1119c may include fileds such as, but not limited to: app_ID, protocol_ID, user_type, app_type, app_version, policy_ID, app_setting, app_interface, app_authentication, and/or the like. A protocol table 1119d may include fields such as, but not limited to protocol_ID, user_ID, protocol_version, protocol request, protocol_compatability, and/or the like. A subscription table 1119e may include fields such as, but not limited to user_ID, hardware_ID, subscription_ID, subscription_type, application_ID, application_type, subscription_time, and/or the like.

In one embodiment, the CO-PLAY database may interact with other database systems. For example, employing a distributed database system, queries and data access by search CO-PLAY component may treat the combination of the CO-PLAY database, an integrated data security layer database as a single database entity. In one embodiment, user programs may contain various user interface primitives, which may serve to update the CO-PLAY. Also, various accounts may require custom database tables depending upon the environments and the types of clients the CO-PLAY may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1119a-e. The CO-PLAY may be configured to keep track of various settings, inputs, and parameters via database controllers.

The CO-PLAY database may communicate to and/or with other components in a component collection, including itself, and/or facilities of the like. Most frequently, the CO-PLAY database communicates with the CO-PLAY component, other program components, and/or the like. The database may contain, retain, and provide information regarding other nodes and data.

### The CO-PLAYs

The CO-PLAY component 1135 is a stored program component that is executed by a CPU. In one embodiment, the CO-PLAY component incorporates any and/or all combinations of the aspects of the CO-PLAY that was discussed in the previous figures. As such, the CO-PLAY affects accessing, obtaining and the provision of information, services, transactions, and/or the like across various communications networks.

The CO-PLAY component enables the configuration, network connection, engagement, remote control, and/or the like and use of the CO-PLAY.

The CO-PLAY component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the CO-PLAY server employs a cryptographic server to encrypt and decrypt communications. The CO-PLAY component may communicate to and/or with other components in a component collection, including itself, and/or facilities of the like. Most frequently, the CO-PLAY component communicates with the CO-PLAY database, operating systems, other program components, and/or the like. The CO-PLAY may contain, communicate, generate, obtain, and/or provide program component, system, user, and/or data communications, requests, and/or responses.

### Distributed CO-PLAYs

The structure and/or operation of any of the CO-PLAY node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the CO-PLAY controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1
where Value1 is discerned as being a parameter because “http://” is part of is the grammar syntax, and what follows is considered part of the post value. Similarly, with such a grammar, a variable “Value1” may be inserted into an “http://” post command and then sent. The grammar syntax itself may be presented as structured data that is interpreted and/or other wise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse communications data. Further, the parsing grammar may be used beyond message parsing, but may also be used to parse: databases, data collections, data stores, structured data, and/or the like. Again, the desired configuration will depend upon the context, environment, and requirements of system deployment.

The entirety of this application (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of claimed inventions. It is further to be understood that, depending on the particular needs and/or characteristics of a CO-PLAY user, administrator, server, data, monetization structure, hardware configuration, network framework, and/or the like, various embodiments of the CO-PLAY may be implemented that facilitate a great deal of flexibility and customization. The instant disclosure discusses embodiments of the CO-PLAY primarily within the context of video gaming applications. However, it is to be understood that the system described herein may be readily configured/customized for a wide range of other applications or implementations. For example, aspects of the CO-PLAY may be adapted for cryptographic communications, artificial intelligence simulations, remote access presentation and/or the like. It is to be understood that the CO-PLAY may be further adapted to other implementations for general network management applications and network protocol designs.

As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be a understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented interactive co-play method, comprising:
receiving a request to initialize an interactive co-play component;
querying for co-play client devices;
providing a list of available co-play client devices based on the query;
obtaining a selection of a co-play client device;
configuring a communications channel for the selected co-play client device; and
instantiating the interactive co-play component through the communications channel.

2. The method of claim 1, wherein querying for co-play client devices comprises:
receiving an indication of co-play client devices; and
search a range of local area network for co-play client devices based on the received indication,
wherein the received indication may be any of an IP address, MAC address, acronym, hardware label, digital signature and driver certificate.

3. The method of claim 1, wherein querying for co-play client devices comprises:
forming a query based on registered co-play client devices on a communication stack database.

4. The method of claim 1, wherein querying for co-play client devices comprises:
locating co-play client devices based on zero configuration protocols,
wherein the zero configuration protocols may be any of Service Location Protocol (SLP), Universal Plug and Play (UPnP), Jini, Bluetooth Service Discovery Protocol, WS-Discovery, Proprietary Discovery Protocol and Bonjour.

5. The method of claim 1, wherein querying for co-play client devices comprises:
searching for active users connected to available co-play client devices on an Internet gaming platform.

6. The method of claim 1, wherein the configured communications channel may be any of Bluetooth, 3G, Wi-Fi and physical connection.

7. The method of claim 1, wherein the configured communications channel is established between a source device and the selected co-play client device.

8. The method of claim 1, wherein instantiating the interactive co-play component through the communications channel comprises:
receiving control inputs via a user interface;
receiving control commands from the client device via the configured communications channel; and
engaging the interactive co-play component based on the received control inputs and the received control commands.

9. The method of claim 8, wherein the received control commands is transmitted based on a Common Object Request Broker Architecture (CORBA) mechanism.

10. The method of claim 8, wherein the received control commands are in the format of a binary data packet, wherein the binary data packet includes fields: message type, sequence number, acknowledgement number, data offset, data length, checksum, options and data payload.

11. The method of claim 8, wherein the received control inputs and the received control commands comprise at least one of accelerometer information, pointer coordinates (pressing on the screen), images, GPS information, user information.

12. The method of claim 8, wherein the interactive co-play component is engaged based on the received control inputs and the received control commands in a real-time manner.

13. The method of claim 1, further comprising:
tethering with a remote display device; and
casting gaming visualization data to drive the remote display.

14. The method of claim 13, wherein the gaming visualization data comprises at least two gaming avatars for co-play.

15. The method of claim 13, wherein the selected co-play device is tethered with the remote display device and sends control commands to the remote display device.

16. The method of claim 13, further comprising:
receiving control commands of the selected co-play client device forwarded by the remote display device.

17. The method of claim 1, further comprising:
establishing a communications channel with a remote gaming server;
providing the selection of co-play client devices to the remote gaming ie server; and
sending control commands to the remote gaming server.

18. The method of claim 17, wherein the remote gaming server receives control commands of the selected co-play client device and engage a co-play platform based on the received control commands from both the selected co-play client device and a source device.

19. An interactive co-play system, comprising:
means to receive a request to initialize an interactive co-play component;
means to query for co-play client devices;
means to provide a list of available co-play client devices based on the query;
means to obtain a selection of a co-play client device;
means to configure a communications channel for the selected co-play client device; and
means to instantiate the interactive co-play component through the communications channel.

20. A processor-readable medium storing a plurality of processing instructions, comprising issuable instructions by a processor to:
receive a request to initialize an interactive co-play component;
query for co-play client devices;
provide a list of available co-play client devices based on the query;
obtain a selection of a co-play client device;
configure a communications channel for the selected co-play client device; and
instantiate the interactive co-play component through the communications channel.
